(19) United States
(12) Patent Application Publication
(10) Pub. No.: US 2019/0347695 A1
(43) Pub. Date: Nov. 14, 2019

(54) SYSTEMS AND METHODS FOR CAPTIVE PORTAL CONTROL AND MANAGEMENT IN A NETWORK OF MOVING THINGS THAT MAY INCLUDE, FOR EXAMPLE, AUTONOMOUS VEHICLES

(71) Applicant: Veniam, Inc., Mountain View, CA (US)

(72) Inventor: Clinton Luís Jorge, Madeira (PT)

(21) Appl. No.: 16/411,241

(22) Filed: May 14, 2019

Related U.S. Application Data
(60) Provisional application No. 62/670,989, filed on May 14, 2018.

(51) Int. Cl. G06Q 30/02

(52) U.S. Cl. CPC G06Q 30/0261; G06Q 30/0266; G06Q 30/0252; G06Q 30/0272; G06Q 30/0273; G06Q 30/0277

(57) ABSTRACT

Communication network architectures, systems, and methods for supporting a network of mobile nodes. As a non-limiting example, various aspects of this disclosure provide communication network architectures, systems, and methods may disclose controlling by a mobile access point (MAP) display of information on a mobile device. This may comprise establishing communication by the MAP with the mobile device. The MAP may provide to the mobile device a party's advertisement to be displayed on the mobile device, additional information for the party's advertisement, and a link to an advertisement page corresponding to the party's advertisement. The MAP may collect from the mobile device user interaction information for transmission to a cloud server for monetization, where the user interaction information comprises one or more of: displaying the party's advertisement, a user selecting the party's advertisement, and the user visiting the advertisement page.

### CLAIM TO PRIORITY/CROSS-REFERENCE TO RELATED APPLICATIONS/INCORPORATION BY REFERENCE

The present application claims priority to and claims benefit from U.S. Provisional Patent Application Ser. No. 62/670,989, filed on May 14, 2018. The contents of the above application are hereby incorporated herein by reference in its entirety.

The present application is related to U.S. Provisional Application Ser. No. 62/221,997, titled “Integrated Communication Network for a Network of Moving Things,” filed on Sep. 22, 2015; U.S. Provisional Application Ser. No. 62/222,016, titled “Systems and Methods for Synchronizing a Network of Moving Things,” filed on Sep. 22, 2015; U.S. Provisional Application Ser. No. 62/222,042, titled “Systems and Methods for Managing a Network of Moving Things,” filed on Sep. 22, 2015; U.S. Provisional Application Ser. No. 62/222,066, titled “Systems and Methods for Monitoring a Network of Moving Things,” filed on Sep. 22, 2015; U.S. Provisional Application Ser. No. 62/222,077, titled “Systems and Methods for Detecting and Classifying Anomalies in a Network of Moving Things,” filed on Sep. 22, 2015; U.S. Provisional Application Ser. No. 62/222,098, titled “Systems and Methods for Managing Mobility in a Network of Moving Things,” filed on Sep. 22, 2015; U.S. Provisional Application Ser. No. 62/222,121, titled “Systems and Methods for Managing Connectivity a Network of Moving Things,” filed on Sep. 22, 2015; U.S. Provisional Application Ser. No. 62/222,135, titled “Systems and Methods for Collecting Sensor Data in a Network of Moving Things,” filed on Sep. 22, 2015; U.S. Provisional Application Ser. No. 62/222,145, titled “Systems and Methods for Interfacing with a Network of Moving Things,” filed on Sep. 22, 2015; U.S. Provisional Application Ser. No. 62/222,150, titled “Systems and Methods for Interfacing with a User of a Network of Moving Things,” filed on Sep. 22, 2015; U.S. Provisional Application Ser. No. 62/222,168, titled “Systems and Methods for Data Storage and Processing for a Network of Moving Things,” filed on Sep. 22, 2015; U.S. Provisional Application Ser. No. 62/222,183, titled “Systems and Methods for Vehicle Traffic Management in a Network of Moving Things,” filed on Sep. 22, 2015; U.S. Provisional Application Ser. No. 62/222,186, titled “Systems and Methods for Environmental Management in a Network of Moving Things,” filed on Sep. 22, 2015; U.S. Provisional Application Ser. No. 62/222,190, titled “Systems and Methods for Port Management in a Network of Moving Things,” filed on Sep. 22, 2015; U.S. Provisional Patent Application Ser. No. 62/222,192, titled “Communication Network of Moving Things,” filed on Sep. 22, 2015; U.S. Provisional Application Ser. No. 62/244,828, titled “Utilizing Historical Data to Correct GPS Data in a Network of Moving Things,” filed on Oct. 22, 2015; U.S. Provisional Application Ser. No. 62/244,930, titled “Using Anchors to Correct GPS Data in a Network of Moving Things,” filed on Oct. 22, 2015; U.S. Provisional Application Ser. No. 62/246,368, titled “Systems and Methods for Inter-Application Communication in a Network of Moving Things,” filed on Oct. 26, 2015; U.S. Provisional Application Ser. No. 62/246,372, titled “Systems and Methods for Probing and Validating Communication in a Network of Moving Things,” filed on Oct. 26, 2015; U.S. Provisional Application Ser. No. 62/250,544, titled “Adaptive Rate Control for Vehicular Networks,” filed on Nov. 4, 2015; U.S. Provisional Application Ser. No. 62/273,878, titled “Systems and Methods for Reconfiguring and Adapting Hardware in a Network of Moving Things,” filed on Dec. 31, 2015; U.S. Provisional Application Ser. No. 62/253,249, titled “Systems and Methods for Optimizing Data Gathering in a Network of Moving Things,” filed on Nov. 10, 2015; U.S. Provisional Application Ser. No. 62/257,421, titled “Systems and Methods for Delay Tolerant Networking in a Network of Moving Things,” filed on Nov. 19, 2015; U.S. Provisional Application Ser. No. 62/265,267, titled “Systems and Methods for Improving Coverage and Throughput of Mobile Access Points in a Network of Moving Things,” filed on Dec. 9, 2015; U.S. Provisional Application Ser. No. 62/270,858, titled “Channel Coordination in a Network of Moving Things,” filed on Dec. 22, 2015; U.S. Provisional Application Ser. No. 62/257,854, titled “Systems and Methods for Network Coded Mesh Networking in a Network of Moving Things,” filed on Nov. 20, 2015; U.S. Provisional Application Ser. No. 62/260,749, titled “Systems and Methods for Improving Fixed Access Point Coverage in a Network of Moving Things,” filed on Nov. 30, 2015; U.S. Provisional Application Ser. No. 62/273,715, titled “Systems and Methods for Managing Mobility Controllers and Their Network Interactions in a Network of Moving Things,” filed on Dec. 31, 2015; U.S. Provisional Application Ser. No. 62/281,432, titled “Systems and Methods for Managing and Triggering Handovers of Mobile Access Points in a Network of Moving Things,” filed on Jan. 21, 2016; U.S. Provisional Application Ser. No. 62/268,188, titled “Captive Portal-related Control and Management in a Network of Moving Things,” filed on Dec. 16, 2015; U.S. Provisional Application Ser. No. 62/270,678, titled “Systems and Methods to Extrapolate High-Value Data from a Network of Moving Things,” filed on Dec. 22, 2015; U.S. Provisional Application Ser. No. 62/272,750, titled “Systems and Methods for Remote Software Update and Distribution in a Network of Moving Things,” filed on Dec. 30, 2015; U.S. Provisional Application Ser. No. 62/278,662, titled “Systems and Methods for Remote Configuration Update and Distribution in a Network of Moving Things,” filed on Jan. 14, 2016; U.S. Provisional Application Ser. No. 62/286,243, titled “Systems and Methods for Adapting a Network of Moving Things Based on User Feedback,” filed on Jan. 22, 2016; U.S. Provisional Application Ser. No. 62/278,764, titled “Systems and Methods to Guarantee Data Integrity When Building Data Analytics in a Network of Moving Things,” Jan. 14, 2016; U.S. Provisional Application Ser. No. 62/286,515, titled “Systems and Methods for Self-Initialization and Automated Bootstrapping of Mobile Access Points in a Network of Moving Things,” filed on Jan. 25, 2016; U.S. Provisional Application Ser. No. 62/295,602, titled “Systems and Methods for Power Management in a Network of Moving Things,” filed on Feb. 16, 2016; and U.S. Provisional Application Ser. No. 62/299,269, titled “Systems and Methods for Automating and Easing the Installation and Setup of the Infrastructure Supporting a Network of Moving Things,” filed on Feb. 24, 2016; each of which is hereby incorporated herein by reference in its entirety for all purposes.

### BACKGROUND

Current communication networks are unable to adequately support communication environments involving mobile and static nodes. As a non-limiting example, current communication networks are unable to adequately support a network comprising a complex array of both moving and static nodes (e.g., the Internet of moving things, autonomous vehicle networks, etc.). Limitations and disadvantages of conventional methods and systems will become apparent to one of skill in the art, through comparison of such approaches with some aspects of the present methods and systems set forth in the remainder of this disclosure with reference to the drawings.

### BRIEF DESCRIPTION OF SEVERAL VIEWS OF THE DRAWINGS

FIG. 1 shows a block diagram of a communication network, in accordance with various aspects of this disclosure.

FIG. 2 shows a block diagram of a communication network, in accordance with various aspects of this disclosure.

FIG. 3 shows a diagram of a metropolitan area network, in accordance with various aspects of this disclosure.

FIG. 4 shows a block diagram of a communication network, in accordance with various aspects of this disclosure.

FIGS. 5A-5C show a plurality of network configurations illustrating the flexibility and/or and resiliency of a communication network, in accordance with various aspects of this disclosure.

FIG. 6 shows yet another block diagram of an example network configuration, in accordance with various aspects of the present disclosure.

FIG. 7 is an illustration of an example journey of a customer/end-user involving an edge captive portal system, in accordance with various aspects of the present disclosure.

FIGS. 8A-8D illustrate an example of how three components, a captive portal control and management functionality, an edge captive portal system in a mobile access point (MAP) such as the example illustrated in FIG. 7 as the captive portal system, and an electronic device of a customer/end-user, may interact in order to extract maximum value from a wireless vehicle mesh network to monetize network or service usage through advertisements, in accordance with various aspects of the present disclosure.

FIG. 9 illustrates an example monetization model for an edge captive portal system using push advertisement notification banners based on two example advertisement categories referred to herein as “normal” and “premium,” in accordance with various aspects of the present disclosure.

FIG. 10 shows an example block diagram of a processing module for use in an entity, in accordance with various aspects of the present disclosure.

### SUMMARY

Various aspects of this disclosure provide communication network architectures, systems and methods for supporting a network of mobile and/or static nodes. As a non-limiting example, various aspects of this disclosure provide communication network architectures, systems, and methods for supporting a dynamically configurable communication network comprising a complex array of both static and moving communication nodes (e.g., the Internet of moving things, autonomous vehicle networks, etc.). For example, a communication network implemented in accordance with various aspects of the present disclosure may operate in one of a plurality of modalities comprising various fixed nodes, mobile nodes, and/or a combination thereof, which are selectable to achieve any of a variety of system goals.

### DETAILED DESCRIPTION OF VARIOUS ASPECTS OF THE DISCLOSURE

As utilized herein the terms “circuits” and “circuitry” refer to physical electronic components (i.e., hardware) and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (i.e., hardware) and any software and/or firmware (“code”) that may configure the hardware, be executed by the hardware, and or otherwise be associated with the hardware.

As utilized herein, circuitry is “operable” to perform a function whenever the circuitry comprises the necessary hardware and code (if any is necessary) to perform the function, regardless of whether performance of the function is disabled, or not enabled (e.g., by a user-configurable setting, factory setting or trim, etc.).

As utilized herein, “and/or” means any one or more of the items in the list joined by “and/or.” As an example, “x and/or y” means any element of the three-element set {(x), (y), (x, y)}. That is, “x and/or y” means “one or both of x and y.” As another example, “x, y, and/or z” means any element of the seven-element set {(x), (y), (z), (x, y), (x, z), (y, z), (x, y, z)}. That is, “x, y, and/or z” means “one or more of x, y, and z.” As utilized herein, the terms “e.g.,” and “for example,” “exemplary,” and the like set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example an electronic device may be turned sideways so that its “top” surface is facing horizontally and its “side” surface is facing vertically, without departing from the teachings of the present disclosure.

With the proliferation of the mobile and/or static things (e.g., devices, machines, people, etc.) and logistics for such things to become connected to each other (e.g., in the contexts of smart logistics, transportation, environmental sensing, etc.), a platform that is for example always-on, robust, scalable and secure that is capable of providing connectivity, services and Internet access to such things (or objects), anywhere and anytime is desirable. Efficient power utilization within the various components of such system is also desirable.

Accordingly, various aspects of the present disclosure provide a fully-operable, always-on, responsive, robust, scalable, secure platform/system/architecture to provide connectivity, services and Internet access to all mobile things and/or static things (e.g., devices, machines, people, access points, end user devices, sensors, etc.) anywhere and anytime, while operating in an energy-efficient manner.

Various aspects of the present disclosure provide a platform that is flexibly configurable and adaptable to the various requirements, features, and needs of different environments, where each environment may be characterized by a respective level of mobility and density of mobile and/or static things, and the number and/or types of access to those things. Characteristics of various environments may, for example, include high mobility of nodes (e.g., causing contacts or connections to be volatile), high number of neighbors, high number of connected mobile users, mobile access points, availability of multiple networks and technologies (e.g., sometimes within a same area), etc. For example, the mode of operation of the platform may be flexibly adapted from environment to environment, based on each environment's respective requirements and needs, which may be different from other environments. Additionally for example, the platform may be flexibly optimized (e.g., at design/installation time and/or in real-time) for different purposes (e.g., to reduce the latency, increase throughput, reduce power consumption, load balance, increase reliability, make more robust with regard to failures or other disturbances, etc.), for example based on the content, service or data that the platform provides or handles within a particular environment.

In accordance with various aspects of the present disclosure, many control and management services (e.g., mobility, security, routing, etc.) are provided on top of the platform (e.g., directly, using control overlays, using containers, etc.), such services being compatible with the services currently deployed on top of the Internet or other communication network(s).

The communication network (or platform), in whole or in part, may for example be operated in public and/or private modes of operation, for example depending on the use case. The platform may, for example, operate in a public or private mode of operation, depending on the use-case (e.g., public Internet access, municipal environment sensing, fleet operation, etc.).

Additionally for example, in an implementation in which various network components are mobile, the transportation and/or signal control mechanisms may be adapted to serve the needs of the particular implementation. Also for example, wireless transmission power and/or rate may be adapted (e.g., to mitigate interference, to reduce power consumption, to extend the life of network components, etc.

Various example implementations of a platform, in accordance with various aspects of the present disclosure, are capable of connecting different subsystems, even when various other subsystems that may normally be utilized are unavailable. For example, the platform may comprise various built-in redundancies and fail-recovery mechanisms. For example, the platform may comprise a self-healing capability, self-configuration capability, self-adaptation capability, etc. The protocols and functions of the platform may, for example, be prepared to be autonomously and smoothly configured and adapted to the requirements and features of different environments characterized by different levels of mobility and density of things (or objects), the number/types of access to those things. For example, various aspects of the platform may gather context parameters that can influence any or all decisions. Such parameters may, for example, be derived locally, gathered from a neighborhood, fixed APs, the Cloud, etc. Various aspects of the platform may also, for example, ask for historical information to feed any of the decisions, where such information can be derived from historical data, from surveys, from simulators, etc. Various aspects of the platform may additionally, for example, probe or monitor decisions made throughout the network, for example to evaluate the network and/or the decisions themselves in real-time. Various aspects of the platform may further, for example, enforce the decisions in the network (e.g., after evaluating the probing results). Various aspects of the platform may, for example, establish thresholds to avoid any decision that is to be constantly or repeatedly performed without any significant advantage (e.g., technology change, certificate change, IP change, etc.). Various aspects of the platform may also, for example, learn locally (e.g., with the decisions performed) and dynamically update the decisions.

In addition to (or instead of) failure robustness, a platform may utilize multiple connections (or pathways) that exist between distinct sub-systems or elements within the same sub-system, to increase the robustness and/or load-balancing of the system.

The following discussion will present examples of the functionality performed by various example subsystems of the communication network. It should be understood that the example functionality discussed herein need not be performed by the particular example subsystem or by a single subsystem. For example, the subsystems present herein may interact with each other, and data or control services may be deployed either in a centralized way, or having their functionalities distributed among the different subsystems, for example leveraging the cooperation between the elements of each subsystem.

Various aspects of the present disclosure provide a communication network (e.g., a city-wide vehicular network, a shipping port-sized vehicular network, a campus-wide vehicular network, etc.) that utilizes vehicles (e.g., automobiles, buses, trucks, boats, forklifts, human-operated vehicles, autonomous and/or remote controlled vehicles, etc.) as Wi-Fi hotspots. Note that Wi-Fi is generally used throughout this discussion as an example, but the scope of various aspects of this disclosure is not limited thereto. For example, other wireless LAN technologies, PAN technologies, MAN technologies, etc., may be utilized. Such utilization may, for example, provide cost-effective ways to gather substantial amounts of urban data, and provide for the efficient offloading of traffic from congested cellular networks (or other networks). In controlled areas (e.g., ports, harbors, etc.) with many vehicles, a communication network in accordance with various aspects of this disclosure may expand the wireless coverage of existing enterprise Wi-Fi networks, for example providing for real-time communication with vehicle drivers (e.g., human, computer-controlled, etc.) and other mobile employees without the need for SIM cards or cellular (or other network) data plans.

Vehicles may have many advantageous characteristics that make them useful as Wi-Fi (or general wireless) hotspots. For example, vehicles generally have at least one battery, vehicles are generally densely spread over the city at street level and/or they are able to establish many contacts with each other in a controlled space, and vehicles can communicate with 10× the range of normal Wi-Fi in the 5.9 GHz frequency band, reserved for intelligent transportation systems in the EU, the U.S., and elsewhere. Note that the scope of this disclosure is not limited to such 5.9 GHz wireless communication. Further, vehicles are able to effectively expand their coverage area into a swath over a period of time, enabling a single vehicle access point to interact with substantially more data sources over the period of time.

In accordance with various aspects of the present disclosure, an affordable multi-network on-board unit (OBU) is presented. Note that the OBU may also be referred to herein as a mobile access point, Mobile AP, MAP, etc. The OBU may, for example, comprise a plurality of networking interfaces (e.g., Wi-Fi, 802.11p, 4G, Bluetooth, UWB, etc.). The OBU may, for example, be readily installed in or on private and/or public vehicles (e.g., individual user vehicles, vehicles of private fleets, vehicles of public fleets, etc.). The OBU may, for example, be installed in transportation fleets, waste management fleets, law enforcement fleets, emergency services, road maintenance fleets, taxi fleets, aircraft fleets, etc. The OBU may, for example, be installed in or on a vehicle or other structure with free mobility or relatively limited mobility. The OBU may also, for example, be carried by a person or service animal, mounted to a bicycle, mounted to a moving machine in general, mounted to a container, etc.

The OBUs may, for example, operate to connect passing vehicles to the wired infrastructure of one or more network providers, telecom operators, etc. In accordance with the architecture, hardware, and software functionality discussed herein, vehicles and fleets can be connected not just to the cellular networks (or other wide area or metropolitan area networks, etc.) and existing Wi-Fi hotspots spread over a city or a controlled space, but also to other vehicles (e.g., utilizing multi-hop communications to a wired infrastructure, single or multi-hop peer-to-peer vehicle communication, etc.). The vehicles and/or fleets may, for example, form an overall mesh of communication links, for example including the OBUs and also fixed Access Points (APs) connected to the wired infrastructure (e.g., a local infrastructure, etc.). Note that OBUs herein may also be referred to as “Mobile APs,” “mobile hotspots,” “MAPs,” etc. Also note that fixed access points may also be referred to herein as Road Side Units (RSUs), Fixed APs, FAPs, etc.

In an example implementation, the OBUs may communicate with the Fixed APs utilizing a relatively long-range protocol (e.g., 802.11p, etc.), and the Fixed APs may, in turn, be hard wired to the wired infrastructure (e.g., via cable, tethered optical link, etc.). Note that Fixed APs may also, or alternatively, be coupled to the infrastructure via wireless link (e.g., 802.11p, etc.). Additionally, clients or user devices may communicate with the OBUs using one or more relatively short-range protocols (e.g., Wi-Fi, Bluetooth, UWB, etc.). The OBUs, for example having a longer effective wireless communication range than typical Wi-Fi access points or other wireless LAN/PAN access points (e.g., at least for links such as those based on 802.11p, etc.), are capable of substantially greater coverage areas than typical Wi-Fi or other wireless LAN/PAN access points, and thus fewer OBUs are necessary to provide blanket coverage over a geographical area.

The OBU may, for example, comprise a robust vehicular networking module (e.g., a connection manager) which builds on long-range communication protocol capability (e.g., 802.11p, etc.). For example, in addition to comprising 802.11p (or other long-range protocol) capability to communicate with Fixed APs, vehicles, and other nodes in the network, the OBU may comprise a network interface (e.g., 802.11a/b/g/n, 802.11ac, 802.11af, any combination thereof, etc.) to provide wireless local area network (WLAN) connectivity to end user devices, sensors, fixed Wi-Fi access points, etc. For example, the OBU may operate to provide in-vehicle Wi-Fi Internet access to users in and/or around the vehicle (e.g., a bus, train car, taxi cab, public works vehicle, etc.). The OBU may further comprise one or more wireless backbone communication interfaces (e.g., cellular network interfaces, etc.). Though in various example scenarios, a cellular network interface (or other wireless backbone communication interface) might not be the preferred interface for various reasons (e.g., cost, power, bandwidth, etc.), the cellular network interface may be utilized to provide connectivity in geographical areas that are not presently supported by a Fixed AP, may be utilized to provide a fail-over communication link, may be utilized for emergency communications, may be utilized to subscribe to local infrastructure access, etc. The cellular network interface may also, for example, be utilized to allow the deployment of solutions that are dependent on the cellular network operators.

An OBU, in accordance with various aspects o the present disclosure, may for example comprise a smart connection manager that can select the best available wireless link(s) (e.g., Wi-Fi, 802.11p, cellular, vehicle mesh, etc.) with which to access the Internet. The OBU may also, for example, provide geo-location capabilities (e.g., GPS, etc.), motion detection sensors to determine if the vehicle is in motion, and a power control subsystem (e.g., to ensure that the OBU does not deplete the vehicle battery, etc.). The OBU may, for example, comprise any or all of the sensors (e.g., environmental sensors, etc.) discussed herein.

The OBU may also, for example, comprise a manager that manages machine-to-machine data acquisition and transfer (e.g., in a real-time or delay-tolerant fashion) to and from the cloud. For example, the OBU may log and/or communicate information of the vehicles.

The OBU may, for example, comprise a connection and/or routing manager that operates to perform routing of communications in a vehicle-to-vehicle/vehicle-to-infrastructure multi-hop communication. A mobility manager (or controller, MC) may, for example, ensure that communication sessions persist over one or more handoff(s) (also referred to herein as a “handover” or “handovers”) (e.g., between different Mobile APs, Fixed APs, base stations, hot spots, etc.), among different technologies (e.g., 802.11p, cellular, Wi-Fi, satellite, etc.), among different MCs (e.g., in a fail-over scenario, load redistribution scenario, etc.), across different interfaces (or ports), etc. Note that the MC may also be referred to herein as a Local Mobility Anchor (LMA), a Network Controller, etc. Note that the MC, or a plurality thereof, may for example be implemented as part of the backbone, but may also, or alternatively, be implemented as part of any of a variety of components or combinations thereof. For example, the MC may be implemented in a Fixed AP (or distributed system thereof), as part of an OBU (or a distributed system thereof), etc. Various non-limiting examples of system components and/or methods are provided in U.S. Provisional Application No. 62/222,098, filed Sep. 22, 2015, and titled “Systems and Method for Managing Mobility in a Network of Moving Things,” the entire contents of which are hereby incorporated herein by reference. Note that in an example implementation including a plurality of MCs, such MCs may be co-located and/or may be geographically distributed.

Various aspects of the present disclosure also provide a cloud-based service-oriented architecture that handles the real-time management, monitoring and reporting of the network and clients, the functionalities required for data storage, processing and management, the Wi-Fi client authentication and Captive Portal display, etc.

A communication network (or component thereof) in accordance with various aspects of the present disclosure may, for example, support a wide range of smart city applications (or controlled scenarios, or connected scenarios, etc.) and/or use-cases, as described herein.

For example, an example implementation may operate to turn each vehicle (e.g., both public and private taxis, buses, trucks, etc.) into a Mobile AP (e.g., a mobile Wi-Fi hotspot), offering Internet access to employees, passengers and mobile users travelling in the city, waiting in bus stops, sitting in parks, etc. Moreover, through an example vehicular mesh network formed between vehicles and/or fleets of vehicles, an implementation may be operable to offload cellular traffic through the mobile Wi-Fi hotspots and/or fixed APs (e.g., 802.11p-based APs) spread over the city and connected to the wired infrastructure of public or private telecom operators in strategic places, while ensuring the widest possible coverage at the lowest possible cost.

An example implementation (e.g., of a communication network and/or components thereof) may, for example, be operable as a massive urban scanner that gathers large amounts of data (e.g., continuously) on-the-move, actionable or not, generated by a myriad of sources spanning from the in-vehicle sensors or On Board Diagnostic System port (e.g., OBD2, etc.), interface with an autonomous vehicle driving system, external Wi-Fi/Bluetooth-enabled sensing units spread over the city, devices of vehicles' drivers and passengers (e.g., information characterizing such devices and/or passengers, etc.), positioning system devices (e.g., position information, velocity information, trajectory information, travel history information, etc.), etc.

Depending on the use case, the OBU may for example process (or computer, transform, manipulate, aggregate, summarize, etc.) the data before sending the data from the vehicle, for example providing the appropriate granularity (e.g., value resolution) and sampling rates (e.g., temporal resolution) for each individual application. For example, the OBU may, for example, process the data in any manner deemed advantageous by the system. The OBU may, for example, send the collected data (e.g., raw data, preprocessed data, information of metrics calculated based on the collected data, etc.) to the Cloud (e.g., to one or more networked servers coupled to any portion of the network) in an efficient and reliable manner to improve the efficiency, environmental impact and social value of municipal city operations and transportation services. Various example use cases are described herein.

In an example scenario in which public buses are moving along city routes and/or taxis are performing their private transportation services, the OBU is able to collect large quantities of real-time data from the positioning systems (e.g., GPS, etc.), from accelerometer modules, etc. The OBU may then, for example, communicate such data to the Cloud, where the data may be processed, reported and viewed, for example to support such public or private bus and/or taxi operations, for example supporting efficient remote monitoring and scheduling of buses and taxis, respectively.

In an example implementation, small cameras (or other sensors) may be coupled to small single-board computers (SBCs) that are placed above the doors of public buses to allow capturing image sequences of people entering and leaving buses, and/or on stops along the bus routes in order to estimate the number of people waiting for a bus. Such data may be gathered by the OBU in order to be sent to the Cloud. With such data, public transportation systems may detect peaks; overcrowded buses, routes and stops; underutilized buses, routes and stops; etc., enabling action to be taken in real-time (e.g., reducing bus periodicity to decrease fuel costs and CO₂ emissions where and when passenger flows are smaller, etc.) as well as detecting systematic transportation problems.

An OBU may, for example, be operable to communicate with any of a variety of Wi-Fi-enabled sensor devices equipped with a heterogeneous collection of environmental sensors. Such sensors may, for example, comprise noise sensors (microphones, etc.), gas sensors (e.g., sensing CO, NO₂, O₃, volatile organic compounds (or VOCs), CO₂, etc.), smoke sensors, pollution sensors, meteorological sensors (e.g., sensing temperature, humidity, luminosity, particles, solar radiation, wind speed (e.g., anemometer), wind direction, rain (e.g., a pluviometer), optical scanners, biometric scanners, cameras, microphones, etc.). Such sensors may also comprise sensors associated with users (e.g., vehicle operators or passengers, passersby, etc.) and/or their personal devices (e.g., smart phones or watches, biometrics sensors, wearable sensors, implanted sensors, etc.). Such sensors may, for example, comprise sensors and/or systems associated with on-board diagnostic (OBD) units for vehicles, autonomous vehicle driving systems, etc. Such sensors may, for example, comprise positioning sensors (e.g., GPS sensors, Galileo sensors, GLONASS sensors, etc.). Note that such positioning sensors may be part of a vehicle's operational system (e.g., a local human-controlled vehicle, an autonomous vehicle, a remote human-controlled vehicle, etc.) Such sensors may, for example, comprise container sensors (e.g., garbage can sensors, shipping container sensors, container environmental sensors, container tracking sensors, etc.).

Once a vehicle enters the vicinity of such a sensor device, a wireless link may be established, so that the vehicle (or OBU thereof) can collect sensor data from the sensor device and upload the collected data to a database in the Cloud. The appropriate action can then be taken. In an example waste management implementation, several waste management (or collection) trucks may be equipped with OBUs that are able to periodically communicate with sensors installed on containers in order to gather information about waste level, time passed since last collection, etc. Such information may then sent to the Cloud (e.g., to a waste management application coupled to the Internet, etc.) through the vehicular mesh network, in order to improve the scheduling and/or routing of waste management trucks. Note that various sensors may always be in range of the Mobile AP (e.g., vehicle-mounted sensors). Note that the sensor may also (or alternatively) be mobile (e.g., a sensor mounted to another vehicle passing by a Mobile AP or Fixed AP, a drone-mounted sensor, a pedestrian-mounted sensor, etc.).

In an example implementation, for example in a controlled space (e.g., a port, harbor, airport, factory, plantation, mine, etc.) with many vehicles, machines and employees, a communication network in accordance with various aspects of the present disclosure may expand the wireless coverage of enterprise and/or local Wi-Fi networks, for example without resorting to a Telco-dependent solution based on SIM cards or cellular fees. In such an example scenario, apart from avoiding expensive cellular data plans, limited data rate and poor cellular coverage in some places, a communication network in accordance with various aspects of the present disclosure is also able to collect and/or communicate large amounts of data, in a reliable and real-time manner, where such data may be used to optimize harbor logistics, transportation operations, etc.

For example in a port and/or harbor implementation, by gathering real-time information on the position, speed, fuel consumption and CO2 emissions of the vehicles, the communication network allows a port operator to improve the coordination of the ship loading processes and increase the throughput of the harbor. Also for example, the communication network enables remote monitoring of drivers' behaviors, behaviors of autonomous vehicles and/or control systems thereof, trucks' positions and engines' status, and then be able to provide real-time notifications to drivers (e.g., to turn on/off the engine, follow the right route inside the harbor, take a break, etc.), for example human drivers and/or automated vehicle driving systems, thus reducing the number and duration of the harbor services and trips. Harbor authorities may, for example, quickly detect malfunctioning trucks and abnormal trucks' circulation, thus avoiding accidents in order to increase harbor efficiency, security, and safety. Additionally, the vehicles can also connect to Wi-Fi access points from harbor local operators, and provide Wi-Fi Internet access to vehicles' occupants and surrounding harbor employees, for example allowing pilots to save time by filing reports via the Internet while still on the water.

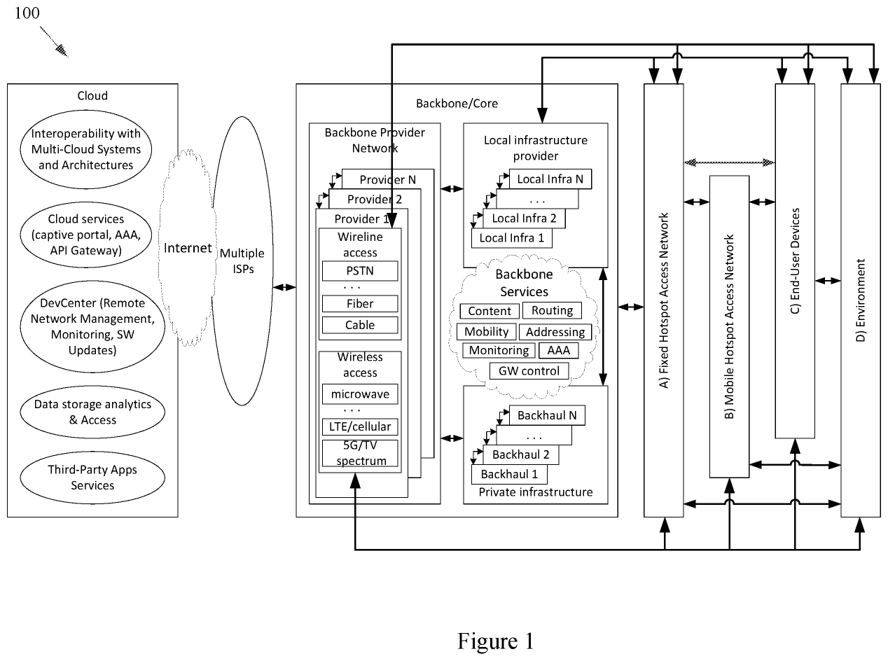

FIG. 1 shows a block diagram of a communication network 100, in accordance with various aspects of this disclosure. Any or all of the functionality discussed herein may be performed by any or all of the example components of the example network 100. Also, the example network 100 may, for example, share any or all characteristics with the other example methods, systems, networks and/or network components 200, 300, 400, 500-570, and 600, discussed herein.

The example network 100, for example, comprises a Cloud that may, for example comprise any of a variety of network level components. The Cloud may, for example, comprise any of a variety of server systems executing applications that monitor and/or control components of the network 100. Such applications may also, for example, manage the collection of information from any of a large array of networked information sources, many examples of which are discussed herein. The Cloud (or a portion thereof) may also be referred to, at times, as an API. For example, Cloud (or a portion thereof) may provide one or more application programming interfaces (APIs) which other devices may use for communicating/interacting with the Cloud.

An example component of the Cloud may, for example, manage interoperability with various multi-cloud systems and architectures. Another example component (e.g., a Cloud service component) may, for example, provide various cloud services (e.g., captive portal services, authentication, authorization, and accounting (AAA) services, API Gateway services, etc.). An additional example component (e.g., a DevCenter component) may, for example, provide network monitoring and/or management functionality, manage the implementation of software updates, etc. A further example component of the Cloud may manage data storage, data analytics, data access, etc. A still further example component of the Cloud may include any of a variety of third-partly applications and services.

The Cloud may, for example, be coupled to the Backbone/Core Infrastructure of the example network 100 via the Internet (e.g., utilizing one or more Internet Service Providers). Though the Internet is provided by example, it should be understood that scope of the present disclosure is not limited thereto.

The Backbone/Core may, for example, comprise any one or more different communication infrastructure components. For example, one or more providers may provide backbone networks or various components thereof. As shown in the example network 100 illustrated in FIG. 1, a Backbone provider may provide wireline access (e.g., PSTN, fiber, cable, etc.). Also for example, a Backbone provider may provide wireless access (e.g., Microwave, LTE/Cellular, 5G/TV Spectrum, etc.).

The Backbone/Core may also, for example, comprise one or more Local Infrastructure Providers. The Backbone/Core may also, for example, comprise a private infrastructure (e.g., run by the network 100 implementer, owner, etc.). The Backbone/Core may, for example, provide any of a variety of Backbone Services (e.g., AAA, Mobility, Monitoring, Addressing, Routing, Content services, Gateway Control services, etc.).

The Backbone/Core Infrastructure may comprise any of a variety of characteristics, non-limiting examples of which are provided herein. For example, the Backbone/Core may be compatible with different wireless or wired technologies for backbone access. The Backbone/Core may also be adaptable to handle public (e.g., municipal, city, campus, etc.) and/or private (e.g., ports, campus, etc.) network infrastructures owned by different local providers, and/or owned by the network implementer or stakeholder. The Backbone/Core may, for example, comprise and/or interface with different Authentication, Authorization, and Accounting (AAA) mechanisms.

The Backbone/Core Infrastructure may, for example, support different modes of operation (e.g., L2 in port implementations, L3 in on-land public transportation implementations, utilizing any one or more of a plurality of different layers of digital IP networking, any combinations thereof, equivalents thereof, etc.) or addressing pools. The Backbone/Core may also for example, be agnostic to the Cloud provider(s) and/or Internet Service Provider(s). Additionally for example, the Backbone/Core may be agnostic to requests coming from any or all subsystems of the network 100 (e.g., Mobile APs or OBUs (On Board Units), Fixed APs or RSUs (Road Side Units), MCs (Mobility Controllers) or LMAs (Local Mobility Anchors) or Network Controllers, etc.) and/or third-party systems.

The Backbone/Core Infrastructure may, for example, comprise the ability to utilize and/or interface with different data storage/processing systems (e.g., MongoDB, MySql, Redis, etc.). The Backbone/Core Infrastructure may further, for example, provide different levels of simultaneous access to the infrastructure, services, data, etc.

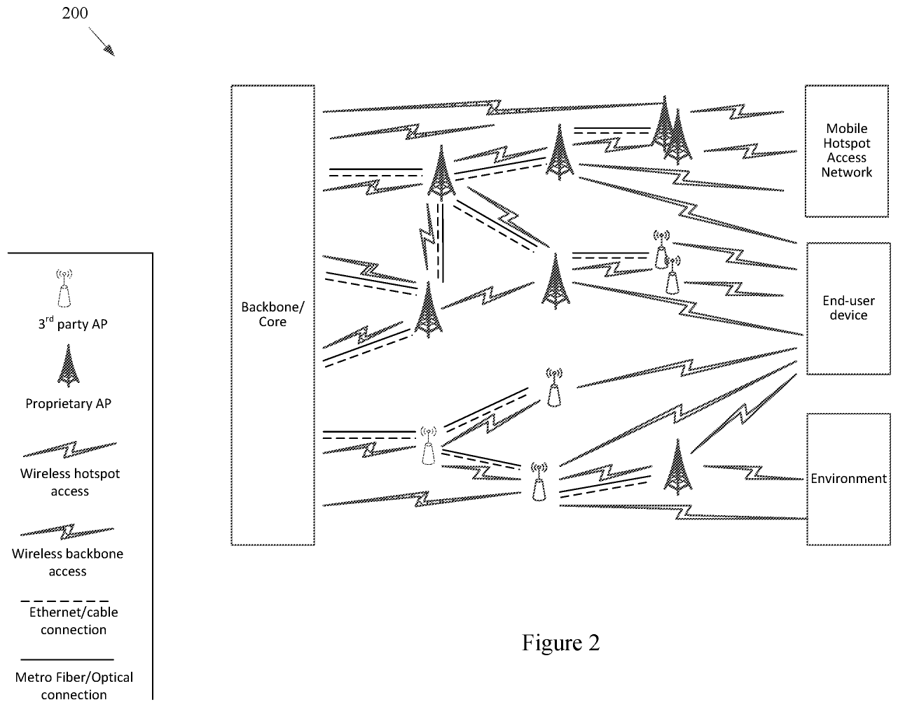

The example network 100 may also, for example, comprise a Fixed Hotspot Access Network. Various example characteristics of such a Fixed Hotspot Access Network 200 are shown at FIG. 2. The example network 200 may, for example, share any or all characteristics with the other example methods, systems, networks and/or network components 100, 300, 400, 500-570, and 600, discussed herein n.

In the example network 200, the Fixed APs (e.g., the proprietary APs, the public third party APs, the private third party APs, etc.) may be directly connected to the local infrastructure provider and/or to the wireline/wireless backbone. Also for example, the example network 200 may comprise a mesh between the various APs via wireless technologies. Note, however, that various wired technologies may also be utilized depending on the implementation. As shown, different fixed hotspot access networks can be connected to a same backbone provider, but may also be connected to different respective backbone providers. In an example implementation utilizing wireless technology for backbone access, such an implementation may be relatively fault tolerant. For example, a Fixed AP may utilize wireless communications to the backbone network (e.g., cellular, 3G, LTE, other wide or metropolitan area networks, etc.) if the backhaul infrastructure is down. Also for example, such an implementation may provide for relatively easy installation (e.g., a Fixed AP with no cable power source that can be placed virtually anywhere).

In the example network 200, the same Fixed AP can simultaneously provide access to multiple Fixed APs, Mobile APs (e.g., vehicle OBUs, etc.), devices, user devices, sensors, things, etc. For example, a plurality of mobile hotspot access networks (e.g., OBU-based networks, etc.) may utilize the same Fixed AP. Also for example, the same Fixed AP can provide a plurality of simultaneous accesses to another single unit (e.g., another Fixed AP, Mobile AP, device, etc.), for example utilizing different channels, different radios, etc.).

Note that a plurality of Fixed APs may be utilized for fault-tolerance/fail-recovery purposes. In an example implementation, a Fixed AP and its fail-over AP may both be normally operational (e.g., in a same switch). Also for example, one or more Fixed APs may be placed in the network at various locations in an inactive or monitoring mode, and ready to become operational when needed (e.g., in response to a fault, in response to an emergency services need, in response to a data surge, etc.).

Referring back to FIG. 1, the example Fixed Hotspot Access Network is shown with a wireless communication link to a backbone provider (e.g., to one or more Backbone Providers and/or Local Infrastructure Providers), to a Mobile Hotspot Access Network, to one or more End User Devices, and to the Environment. Also, the example Fixed Hotspot Access Network is shown with a wired communication link to one or more Backbone Providers, to the Mobile Hotspot Access Network, to one or more End User Devices, and to the Environment. The Environment may comprise any of a variety of devices (e.g., in-vehicle networks, devices, and sensors; autonomous vehicle networks, devices, and sensors; maritime (or watercraft) and port networks, devices, and sensors; general controlled-space networks, devices, and sensors; residential networks, devices, and sensors; disaster recovery & emergency networks, devices, and sensors; military and aircraft networks, devices, and sensors; smart city networks, devices, and sensors; event (or venue) networks, devices, and sensors; underwater and underground networks, devices, and sensors; agricultural networks, devices, and sensors; tunnel (auto, subway, train, etc.) networks, devices, and sensors; parking networks, devices, and sensors; security and surveillance networks, devices, and sensors; shipping equipment and container networks, devices, and sensors; environmental control or monitoring networks, devices, and sensors; municipal networks, devices, and sensors; waste management networks, devices, and sensors, road maintenance networks, devices, and sensors, traffic management networks, devices, and sensors; advertising networks, devices and sensors; etc.).

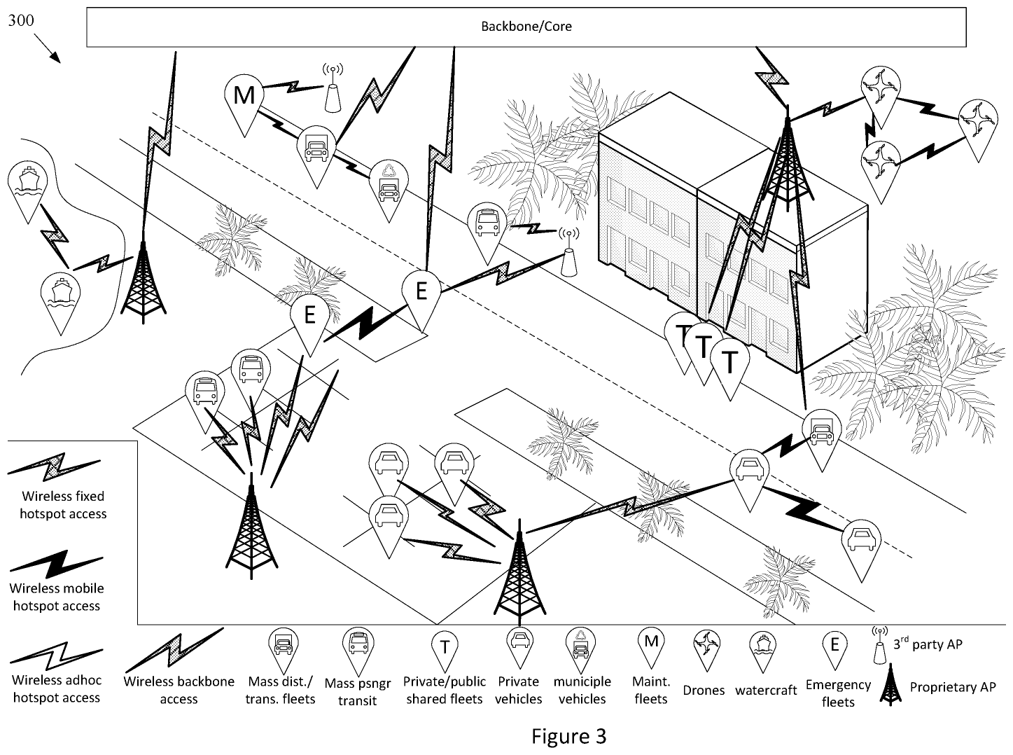

The example network 100 of FIG. 1 also comprises a Mobile Hotspot Access Network. Various example characteristics of such a Mobile Hotspot Access Network 300 are shown at FIG. 3. Note that various fixed network components (e.g., Fixed APs) are also illustrated. The example network 300 may, for example, share any or all characteristics with the other example methods, systems, networks and/or network components 100, 200, 400, 500-570, and 600, discussed herein.

The example network 300 comprises a wide variety of Mobile APs (or hotspots) that provide access to user devices, provide for sensor data collection, provide multi-hop connectivity to other Mobile APs, etc. For example, the example network 300 comprises vehicles from different fleets (e.g., aerial, terrestrial, underground, (under)water, etc.). For example, the example network 300 comprises one or more mass distribution/transportation fleets, one or more mass passenger transportation fleets, private/public shared-user fleets, private vehicles, urban and municipal fleets, maintenance fleets, drones, watercraft (e.g., boats, ships, speedboats, tugboats, barges, etc.), emergency fleets (e.g., police, ambulance, firefighter, etc.), etc.

The example network 300, for example, shows vehicles from different fleets directly connected and/or mesh connected, for example using same or different communication technologies. The example network 300 also shows fleets simultaneously connected to different Fixed APs, which may or may not belong to different respective local infrastructure providers. As a fault-tolerance mechanism, the example network 300 may for example comprise the utilization of long-range wireless communication network (e.g., cellular, 3G, 4G, LTE, etc.) in vehicles if the local network infrastructure is down or otherwise unavailable. A same vehicle (e.g., Mobile AP or OBU) can simultaneously provide access to multiple vehicles, devices, things, etc., for example using a same communication technology (e.g., shared channels and/or different respective channels thereof) and/or using a different respective communication technology for each. Also for example, a same vehicle can provide multiple accesses to another vehicle, device, thing, etc., for example using a same communication technology (e.g., shared channels and/or different respective channels thereof, and/or using a different communication technology).

Additionally, multiple network elements may be connected together to provide for fault-tolerance or fail recovery, increased throughput, or to achieve any or a variety of a client's networking needs, many of examples of which are provided herein. For example, two Mobile APs (or OBUs) may be installed in a same vehicle, etc.

Referring back to FIG. 1, the example Mobile Hotspot Access Network is shown with a wireless communication link to a backbone provider (e.g., to one or more Backbone Providers and/or Local Infrastructure Providers), to a Fixed Hotspot Access Network, to one or more End User Device, and to the Environment (e.g., to any one of more of the sensors or systems discussed herein, any other device or machine, etc.). Though the Mobile Hotspot Access Network is not shown having a wired link to the various other components, there may (at least at times) be such a wired link, at least temporarily.

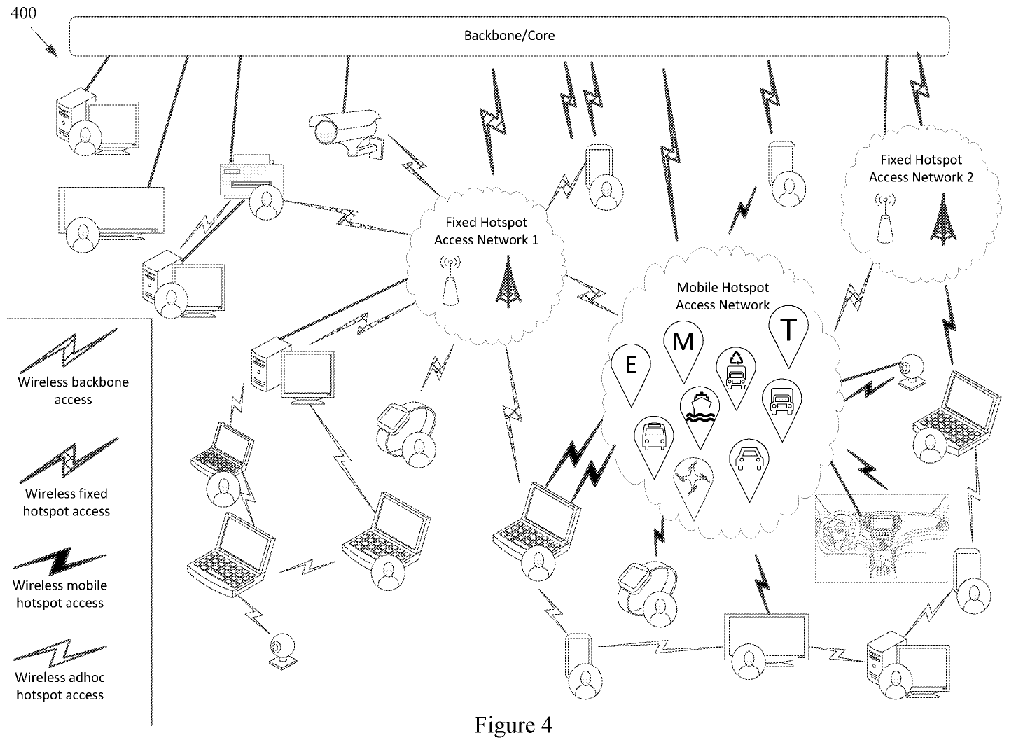

The example network 100 of FIG. 1 also comprises a set of End-User Devices. Various example end user devices are shown at FIG. 4. Note that various other network components (e.g., Fixed Hotspot Access Networks, Mobile Hotspot Access Network(s), the Backbone/Core, etc.) are also illustrated. The example network 400 may, for example, share any or all characteristics with the other example methods, systems, networks and/or network components 100, 200, 300, 500-570, and 600, discussed herein.

The example network 400 shows various mobile networked devices. Such network devices may comprise end-user devices (e.g., smartphones, tablets, smartwatches, laptop computers, webcams, personal gaming devices, personal navigation devices, personal media devices, personal cameras, health-monitoring devices, personal location devices, monitoring panels, printers, etc.). Such networked devices may also comprise any of a variety of devices operating in the general environment, where such devices might not for example be associated with a particular user (e.g. any or all of the sensor devices discussed herein, vehicle sensors, municipal sensors, fleet sensors road sensors, environmental sensors, security sensors, traffic sensors, waste sensors, meteorological sensors, any of a variety of different types of municipal or enterprise equipment, etc.). Any of such networked devices can be flexibly connected to distinct backbone, fixed hotspot access networks, mobile hotspot access networks, etc., using the same or different wired/wireless technologies.

A mobile device may, for example, operate as an AP to provide simultaneous access to multiple devices/things, which may then form ad hoc networks, interconnecting devices ultimately connected to distinct backbone networks, fixed hotspot, and/or mobile hotspot access networks. Devices (e.g., any or all of the devices or network nodes discussed herein) may, for example, have redundant technologies to access distinct backbone, fixed hotspot, and/or mobile hotspot access networks, for example for fault-tolerance and/or load-balancing purposes (e.g., utilizing multiple SIM cards, etc.). A device may also, for example, simultaneously access distinct backbone, fixed hotspot access networks, and/or mobile hotspot access networks, belonging to the same provider or to different respective providers. Additionally for example, a device can provide multiple accesses to another device/thing (e.g., via different channels, radios, etc.).

Referring back to FIG. 1, the example End-User Devices are shown with a wireless communication link to a backbone provider (e.g., to one or more Backbone Providers and/or Local Infrastructure Providers), to a Fixed Hotspot Access Network, to a Mobile Hotspot Access Network, and to the Environment. Also for example, the example End-User Devices are shown with a wired communication link to a backbone provider, to a Fixed Hotspot Access Network, to a Mobile Hotspot Access Network, and to the Environment.

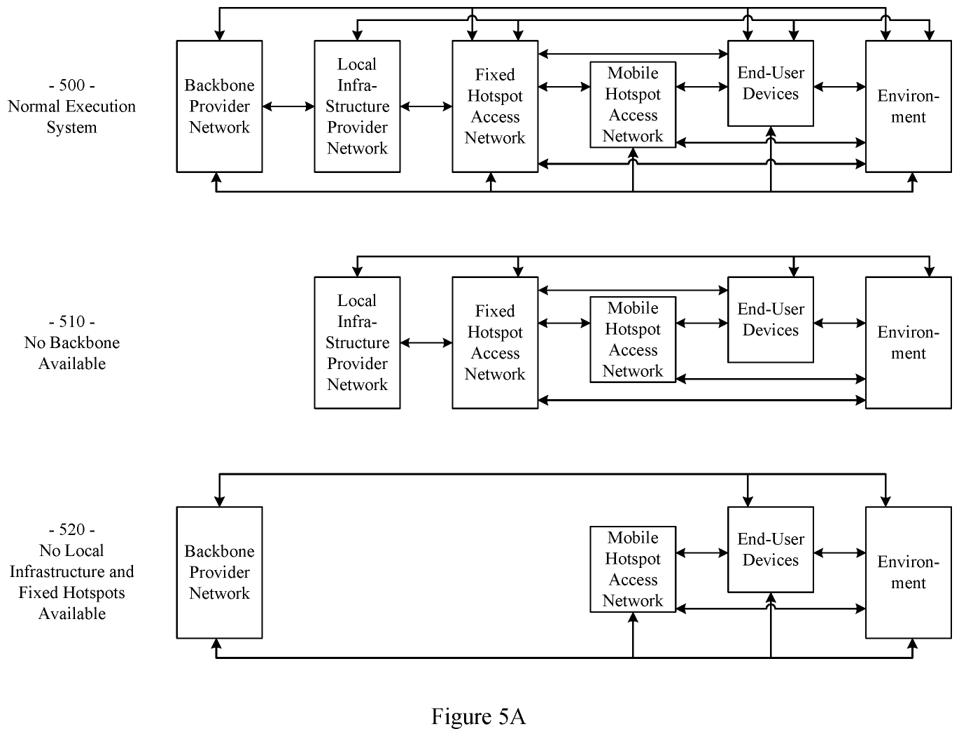

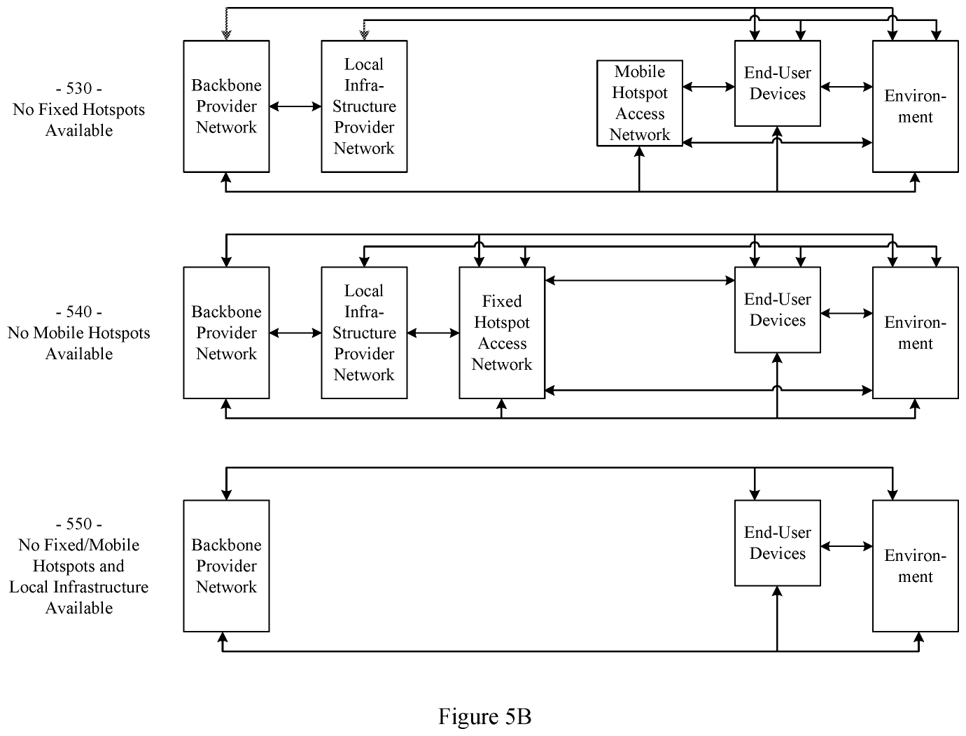

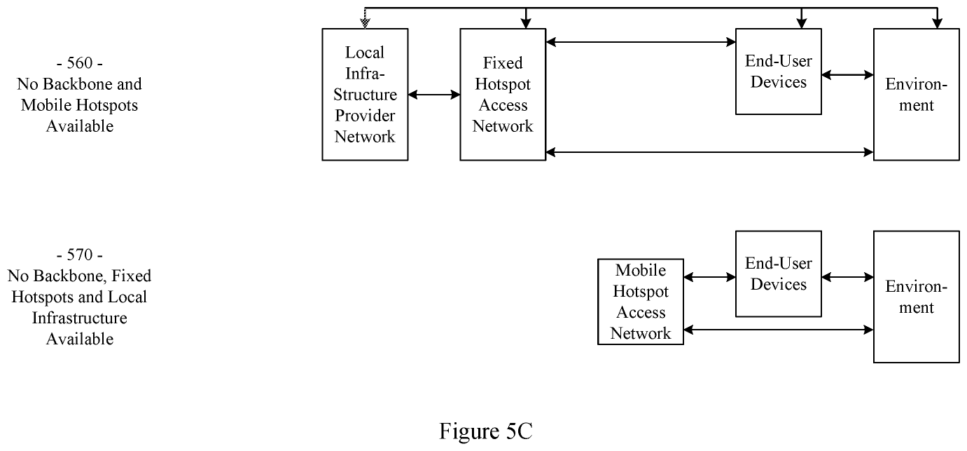

The example network 100 illustrated in FIG. 1 has a flexible architecture that is adaptable at implementation time (e.g., for different use cases) and/or adaptable in real-time, for example as network components enter and leave service. FIGS. 5A-5C illustrate such flexibility by providing example modes (or configurations). The example networks 500-570 may, for example, share any or all characteristics with the other example methods, systems, networks and/or network components 100, 200, 300, 400, and 600, discussed herein. For example and without limitation, any or all of the communication links (e.g., wired links, wireless links, etc.) shown in the example networks 500-570 are generally analogous to similarly positioned communication links shown in the example network 100 of FIG. 1.

For example, various aspects of this disclosure provide communication network architectures, systems, and methods for supporting a dynamically configurable communication network comprising a complex array of both static and moving communication nodes (e.g., the Internet of moving things). For example, a communication network implemented in accordance with various aspects of the present disclosure may operate in one of a plurality of modalities comprising various fixed nodes, mobile nodes, and/or a combination thereof, which are selectable to yield any of a variety of system goals (e.g., increased throughput, reduced latency and packet loss, increased availability and robustness of the system, extra redundancy, increased responsiveness, increased security in the transmission of data and/or control packets, reduced number of configuration changes by incorporating smart thresholds (e.g., change of technology, change of certificate, change of IP, etc.), providing connectivity in dead zones or zones with difficult access, reducing the costs for maintenance and accessing the equipment for updating/upgrading, etc.). At least some of such modalities may, for example, be entirely comprised of fixed-position nodes, at least temporarily if not permanently.

For illustrative simplicity, many of the example aspects shown in the example system or network 100 of FIG. 1 (and other Figures herein) are omitted from FIGS. 5A-5C, but may be present. For example, the Cloud, Internet, and ISP aspects shown in FIG. 1 and in other Figures are not explicitly shown in FIGS. 5A-5C, but may be present in any of the example configurations (e.g., as part of the backbone provider network or coupled thereto, as part of the local infrastructure provider network or coupled thereto, etc.).

For example, the first example mode 500 is presented as a normal execution mode, for example a mode (or configuration) in which all of the components discussed herein are present. For example, the communication system in the first example mode 500 comprises a backbone provider network, a local infrastructure provider network, a fixed hotspot access network, a mobile hotspot access network, end-user devices, and environment devices.

As shown in FIG. 5A, and in FIG. 1 in more detail, the backbone provider network may be communicatively coupled to any or all of the other elements present in the first example mode 500 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via a wired link. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the first example mode 500 (or configuration) via one or more wireless links (e.g., RF link, non-tethered optical link, etc.). For example, the backbone provider network may be communicatively coupled to the fixed hotspot access network (or any component thereof), the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

Though not shown in the first example mode 500 (or any of the example modes of FIGS. 5A-5C), one or more servers may be communicatively coupled to the backbone provider network and/or the local infrastructure network. FIG. 1 provides an example of cloud servers being communicatively coupled to the backbone provider network via the Internet.

As additionally shown in FIG. 5A, and in FIG. 1 in more detail, the local infrastructure provider network may be communicatively coupled to any or all of the other elements present in the first example mode 500 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the first example mode 500 (or configuration) via one or more wireless links (e.g., RF link, non-tethered optical link, etc.). For example, the local infrastructure provider network may be communicatively coupled to the backbone provider network (or any component thereof), the fixed hotspot access network (or any component thereof), the mobile hotspot access network (or any component thereof), the end-user devices, and/or environment devices via one or more wireless links. Note that the communication link shown in the first example mode 500 of FIG. 5A between the local infrastructure provider network and the fixed hotspot access network may be wired and/or wireless.

The fixed hotspot access network is also shown in the first example mode 500 to be communicatively coupled to the mobile hotspot access network, the end-user devices, and/or environment devices via one or more wireless links. Many examples of such wireless coupling are provided herein. Additionally, the mobile hotspot access network is further shown in the first example mode 500 to be communicatively coupled to the end-user devices and/or environment devices via one or more wireless links. Many examples of such wireless coupling are provided herein. Further, the end-user devices are also shown in the first example mode 500 to be communicatively coupled to the environment devices via one or more wireless links. Many examples of such wireless coupling are provided herein. Note that in various example implementations any of such wireless links may instead (or in addition) comprise a wired (or tethered) link.

In the first example mode 500 (e.g., the normal mode), information (or data) may be communicated between an end-user device and a server (e.g., a computer system) via the mobile hotspot access network, the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network, the local infrastructure provider network, and/or the backbone provider network (e.g., skipping the mobile hotspot access network). Also for example, information communicated between an end user device and a server may be communicated via the backbone provider network (e.g., skipping the mobile hotspot access network, fixed hotspot access network, and/or local infrastructure provider network).

Similarly, in the first example mode 500 (e.g., the normal mode), information (or data) may be communicated between an environment device and a server via the mobile hotspot access network, the fixed hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network, the local infrastructure provider network, and/or the backbone provider network (e.g., skipping the mobile hotspot access network). Also for example, information communicated between an environment device and a server may be communicated via the backbone provider network (e.g., skipping the mobile hotspot access network, fixed hotspot access network, and/or local infrastructure provider network). Additionally for example, information communicated between an environment device and a server may be communicated via the local infrastructure provider network (e.g., skipping the mobile hotspot access network and/or fixed hotspot access network).

As discussed herein, the example networks presented herein are adaptively configurable to operate in any of a variety of different modes (or configurations). Such adaptive configuration may occur at initial installation and/or during subsequent controlled network evolution (e.g., adding or removing any or all of the network components discussed herein, expanding or removing network capacity, adding or removing coverage areas, adding or removing services, etc.). Such adaptive configuration may also occur in real-time, for example in response to real-time changes in network conditions (e.g., networks or components thereof being available or not based on vehicle or user-device movement, network or component failure, network or component replacement or augmentation activity, network overloading, etc.). The following example modes are presented to illustrate characteristics of various modes in which a communication system may operate in accordance with various aspects of the present disclosure. The following example modes will generally be discussed in relation to the first example mode 500 (e.g., the normal execution mode). Note that such example modes are merely illustrative and not limiting.

The second example mode (or configuration) 510 (e.g., a no backbone available mode) may, for example, share any or all characteristics with the first example mode 500, albeit without the backbone provider network and communication links therewith. For example, the communication system in the second example mode 510 comprises a local infrastructure provider network, a fixed hotspot access network, a mobile hotspot access network, end-user devices, and environment devices.

As shown in FIG. 5A, and in FIG. 1 in more detail, the local infrastructure provider network may be communicatively coupled to any or all of the other elements present in the second example mode 510 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the second example mode 510 (or configuration) via one or more wireless links (e.g., RF link, non-tethered optical link, etc.). For example, the local infrastructure provider network may be communicatively coupled to the fixed hotspot access network (or any component thereof), the mobile hotspot access network (or any component thereof), the end-user devices, and/or environment devices via one or more wireless links. Note that the communication link(s) shown in the second example mode 510 of FIG. 5A between the local infrastructure provider network and the fixed hotspot access network may be wired and/or wireless.

The fixed hotspot access network is also shown in the second example mode 510 to be communicatively coupled to the mobile hotspot access network, the end-user devices, and/or environment devices via one or more wireless links. Many examples of such wireless coupling are provided herein. Additionally, the mobile hotspot access network is further shown in the second example mode 510 to be communicatively coupled to the end-user devices and/or environment devices via one or more wireless links. Many examples of such wireless coupling are provided herein. Further, the end-user devices are also shown in the second example mode 510 to be communicatively coupled to the environment devices via one or more wireless links. Many examples of such wireless coupling are provided herein. Note that in various example implementations any of such wireless links may instead (or in addition) comprise a wired (or tethered) link.

In the second example mode 510 (e.g., the no backbone available mode), information (or data) may be communicated between an end-user device and a server (e.g., a computer, etc.) via the mobile hotspot access network, the fixed hotspot access network, and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network and/or the local infrastructure provider network (e.g., skipping the mobile hotspot access network). Also for example, information communicated between an end user device and a server may be communicated via the local infrastructure provider network (e.g., skipping the mobile hotspot access network and/or fixed hotspot access network).

Similarly, in the second example mode 510 (e.g., the no backbone available mode), information (or data) may be communicated between an environment device and a server via the mobile hotspot access network, the fixed hotspot access network, and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network and/or the local infrastructure provider network (e.g., skipping the mobile hotspot access network). Also for example, information communicated between an environment device and a server may be communicated via the local infrastructure provider network (e.g., skipping the mobile hotspot access network and/or fixed hotspot access network).

The second example mode 510 may be utilized for any of a variety of reasons, non-limiting examples of which are provided herein. For example, due to security and/or privacy goals, the second example mode 510 may be utilized so that communication access to the public Cloud systems, the Internet in general, etc., is not allowed. For example, all network control and management functions may be within the local infrastructure provider network (e.g., wired local network, etc.) and/or the fixed access point network.

In an example implementation, the communication system might be totally owned, operated and/or controlled by a local port authority. No extra expenses associated with cellular connections need be spent. For example, cellular connection capability (e.g., in Mobile APs, Fixed APs, end user devices, environment devices, etc.) need not be provided. Note also that the second example mode 510 may be utilized in a scenario in which the backbone provider network is normally available but is currently unavailable (e.g., due to server failure, due to communication link failure, due to power outage, due to a temporary denial of service, etc.).

The third example mode (or configuration) 520 (e.g., a no local infrastructure and fixed hotspots available mode) may, for example, share any or all characteristics with the first example mode 500, albeit without the local infrastructure provider network, the fixed hotspot access network, and communication links therewith. For example, the communication system in the third example mode 520 comprises a backbone provider network, a mobile hotspot access network, end-user devices, and environment devices.

As shown in FIG. 5A, and in FIG. 1 in more detail, the backbone provider network may be communicatively coupled to any or all of the other elements present in the third example mode 520 (or configuration) via one or more wired (or tethered) links. For example, the backbone provider network may be communicatively coupled to the end-user devices and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the third example mode 520 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links.

The mobile hotspot access network is further shown in the third example mode 520 to be communicatively coupled to the end-user devices and/or environment devices via one or more wireless links. Many examples of such wireless coupling are provided herein. Further, the end-user devices are also shown in the third example mode 520 to be communicatively coupled to the environment devices via one or more wireless links. Many examples of such wireless coupling are provided herein. Note that in various example implementations any of such wireless links may instead (or in addition) comprise a wired (or tethered) link.

In the third example mode 520 (e.g., the no local infrastructure and fixed hotspots available mode), information (or data) may be communicated between an end-user device and a server (e.g., a computer, etc.) via the mobile hotspot access network and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the backbone provider network (e.g., skipping the mobile hotspot access network).

Similarly, in the third example mode 520 (e.g., the no local infrastructure and fixed hotspots available mode), information (or data) may be communicated between an environment device and a server via the mobile hotspot access network and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the backbone provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the backbone provider network (e.g., skipping the mobile hotspot access network).

In the third example mode 520, all control/management functions may for example be implemented within the Cloud. For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The third example mode 520 may be utilized for any of a variety of reasons, non-limiting examples of which are provided herein. In an example implementation, the third example mode 520 may be utilized in an early stage of a larger deployment, for example deployment that will grow into another mode (e.g., the example first mode 500, example fourth mode 530, etc.) as more communication system equipment is installed. Note also that the third example mode 520 may be utilized in a scenario in which the local infrastructure provider network and fixed hotspot access network are normally available but are currently unavailable (e.g., due to equipment failure, due to communication link failure, due to power outage, due to a temporary denial of service, etc.).

The fourth example mode (or configuration) 530 (e.g., a no fixed hotspots available mode) may, for example, share any or all characteristics with the first example mode 500, albeit without the fixed hotspot access network and communication links therewith. For example, the communication system in the fourth example mode 530 comprises a backbone provider network, a local infrastructure provider network, a mobile hotspot access network, end-user devices, and environment devices.

As shown in FIG. 5B, and in FIG. 1 in more detail, the backbone provider network may be communicatively coupled to any or all of the other elements present in the fourth example mode 530 (or configuration) via one or more wired (or tethered) links. For example, the backbone provider network may be communicatively coupled to the local infrastructure provider network (or any component thereof), the end-user devices, and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5B, and in FIG. 1 in more detail, the backbone provider network may be communicatively coupled to any or all of the other elements present in the fourth example mode 530 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fourth example mode 530 (or configuration) via one or more wired (or tethered) links. For example, the local infrastructure provider network may be communicatively coupled to the backbone provider network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fourth example mode 530 (or configuration) via one or more wireless links (e.g., RF link, non-tethered optical link, etc.). For example, the local infrastructure provider network may be communicatively coupled to the backbone provider network (or any component thereof), the mobile hotspot access network (or any component thereof), the end-user devices, and/or environment devices via one or more wireless links.

The mobile hotspot access network is further shown in the fourth example mode 530 to be communicatively coupled to the end-user devices and/or environment devices via one or more wireless links. Many examples of such wireless coupling are provided herein. Further, the end-user devices are also shown in the fourth example mode 530 to be communicatively coupled to the environment devices via one or more wireless links. Many examples of such wireless coupling are provided herein.

In the fourth example mode 530 (e.g., the no fixed hotspots mode), information (or data) may be communicated between an end-user device and a server via the mobile hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network and/or the backbone provider network (e.g., skipping the mobile hotspot access network). Also for example, information communicated between an end user device and a server may be communicated via the backbone provider network (e.g., skipping the mobile hotspot access network and/or local infrastructure provider network).

Similarly, in the fourth example mode 530 (e.g., the no fixed hotspots available mode), information (or data) may be communicated between an environment device and a server via the mobile hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the mobile hotspot access network). Also for example, information communicated between an environment device and a server may be communicated via the backbone provider network (e.g., skipping the mobile hotspot access network and/or local infrastructure provider network). Additionally for example, information communicated between an environment device and a server may be communicated via the local infrastructure provider network (e.g., skipping the mobile hotspot access network and/or backbone provider network).

In the fourth example mode 530, in an example implementation, some of the control/management functions may for example be implemented within the local backbone provider network (e.g., within a client premises). For example, communication to the local infrastructure provider may be performed through the backbone provider network (or Cloud). Note that in a scenario in which there is a direct communication pathway between the local infrastructure provider network and the mobile hotspot access network, such communication pathway may be utilized.

For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The fourth example mode 530 may be utilized for any of a variety of reasons, non-limiting examples of which are provided herein. In an example implementation, the fourth example mode 530 may be utilized in an early stage of a larger deployment, for example a deployment that will grow into another mode (e.g., the example first mode 500, etc.) as more communication system equipment is installed. The fourth example mode 530 may, for example, be utilized in a scenario in which there is no fiber (or other) connection available for Fixed APs (e.g., in a maritime scenario, in a plantation scenario, etc.), or in which a Fixed AP is difficult to access or connect. For example, one or more Mobile APs of the mobile hotspot access network may be used as gateways to reach the Cloud. The fourth example mode 530 may also, for example, be utilized when a vehicle fleet and/or the Mobile APs associated therewith are owned by a first entity and the Fixed APs are owned by another entity, and there is no present agreement for communication between the Mobile APs and the Fixed APs. Note also that the fourth example mode 530 may be utilized in a scenario in which the fixed hotspot access network is normally available but are currently unavailable (e.g., due to equipment failure, due to communication link failure, due to power outage, due to a temporary denial of service, etc.).

The fifth example mode (or configuration) 540 (e.g., a no mobile hotspots available mode) may, for example, share any or all characteristics with the first example mode 500, albeit without the mobile hotspot access network and communication links therewith. For example, the communication system in the fifth example mode 540 comprises a backbone provider network, a local infrastructure provider network, a fixed hotspot access network, end-user devices, and environment devices.

As shown in FIG. 5B, and in FIG. 1 in more detail, the backbone provider network may be communicatively coupled to any or all of the other elements present in the fifth example mode 540 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via one or more wired links. Note that such a wired coupling may be temporary.

Also shown in FIG. 5B, and in FIG. 1 in more detail, the backbone provider network may be communicatively coupled to any or all of the other elements present in the fifth example mode 540 (or configuration) via one or more wireless links (e.g., RF link, non-tethered optical link, etc.). For example, the backbone provider network may be communicatively coupled to the fixed hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fifth example mode 540 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fifth example mode 540 (or configuration) via one or more wireless links (e.g., RF link, non-tethered optical link, etc.). For example, the local infrastructure provider network may be communicatively coupled to the backbone provider network, the fixed hotspot access network (or any component thereof), the end-user devices, and/or environment devices via one or more wireless links. Note that the communication link(s) shown in the fifth example mode 540 of FIG. 5B between the local infrastructure provider network and the fixed hotspot access network may be wired and/or wireless.

The fixed hotspot access network is also shown in the fifth example mode 540 to be communicatively coupled to the end-user devices and/or environment devices via one or more wireless links. Many examples of such wireless coupling are provided herein. Further, the end-user devices are also shown in the fifth example mode 540 to be communicatively coupled to the environment devices via one or more wireless links. Many examples of such wireless coupling are provided herein.

In the fifth example mode 540 (e.g., the no mobile hotspots available mode), information (or data) may be communicated between an end-user device and a server via the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network, and/or the backbone provider network (e.g., skipping the fixed hotspot access network). Also for example, information communicated between an end user device and a server may be communicated via the backbone provider network (e.g., skipping the fixed hotspot access network and/or local infrastructure provider network).

Similarly, in the fifth example mode 540 (e.g., the no mobile hotspots available mode), information (or data) may be communicated between an environment device and a server via the fixed hotspot access network, the local infrastructure provider network, and/or the backbone provider network. Also for example, an environment device may communicate with or through an end-user device (e.g., instead of or in addition to the fixed hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the fixed hotspot access network). Also for example, information communicated between an environment device and a server may be communicated via the backbone provider network (e.g., skipping the fixed hotspot access network and/or local infrastructure provider network). Additionally for example, information communicated between an environment device and a server may be communicated via the local infrastructure provider network (e.g., skipping the fixed hotspot access network and/or the backbone provider network).

In the fifth example mode 540, in an example implementation, the end-user devices and environment devices may communicate directly to Fixed APs (e.g., utilizing Ethernet, Wi-Fi, etc.). Also for example, the end-user devices and/or environment devices may communicate directly with the backbone provider network (e.g., utilizing cellular connections, etc.).

The fifth example mode 540 may be utilized for any of a variety of reasons, non-limiting examples of which are provided herein. In an example implementation in which end-user devices and/or environment devices may communicate directly with Fixed APs, such communication may be utilized instead of Mobile AP communication. For example, the fixed hotspot access network might provide coverage for all desired areas.

Note also that the fifth example mode 540 may be utilized in a scenario in which the fixed hotspot access network is normally available but is currently unavailable (e.g., due to equipment failure, due to communication link failure, due to power outage, due to a temporary denial of service, etc.).

The sixth example mode (or configuration) 550 (e.g., the no fixed/mobile hotspots and local infrastructure available mode) may, for example, share any or all characteristics with the first example mode 500, albeit without the local infrastructure provider network, fixed hotspot access network, mobile hotspot access network, and communication links therewith. For example, the communication system in the sixth example mode 550 comprises a backbone provider network, end-user devices, and environment devices.

As shown in FIG. 5B, and in FIG. 1 in more detail, the backbone provider network may be communicatively coupled to any or all of the other elements present in the sixth example mode 550 (or configuration) via one or more wired (or tethered) links. For example, the backbone provider network may be communicatively coupled to the end-user devices and/or environment devices via one or more wired links. Note that such a wired coupling may be temporary.

Also shown in FIG. 5B, and in FIG. 1 in more detail, the backbone provider network may be communicatively coupled to any or all of the other elements present in the sixth example mode 550 (or configuration) via one or more wireless links (e.g., RF link, non-tethered optical link, etc.). For example, the backbone provider network may be communicatively coupled to the end-user devices and/or environment devices via one or more wireless links.

The end-user devices are also shown in the sixth example mode 550 to be communicatively coupled to the environment devices via one or more wireless links. Many examples of such wireless coupling are provided herein.

In the sixth example mode 550 (e.g., the no fixed/mobile hotspots and local infrastructure available mode), information (or data) may be communicated between an end-user device and a server via the backbone provider network. Similarly, in the sixth example mode 550 (e.g., the no fixed/mobile hotspots and local infrastructure mode), information (or data) may be communicated between an environment device and a server via the backbone provider network. Also for example, an environment device may communicate with or through an end-user device (e.g., instead of or in addition to the mobile hotspot access network).

The sixth example mode 550 may be utilized for any of a variety of reasons, non-limiting examples of which are provided herein. In an example implementation, for example in which an end-user has not yet subscribed to the communication system, the end-user device may subscribe to the system through a Cloud application and by communicating directly with the backbone provider network (e.g., via cellular link, etc.). The sixth example mode 550 may also, for example, be utilized in rural areas in which Mobile AP presence is sparse, Fixed AP installation is difficult or impractical, etc.

Note also that the sixth example mode 550 may be utilized in a scenario in which the infrastructure provider network, fixed hotspot access network, and/or mobile hotspot access network are normally available but are currently unavailable (e.g., due to equipment failure, due to communication link failure, due to power outage, due to a temporary denial of service, etc.).

The seventh example mode (or configuration) 560 (e.g., the no backbone and mobile hotspots available mode) may, for example, share any or all characteristics with the first example mode 500, albeit without the backbone provider network, mobile hotspot access network, and communication links therewith. For example, the communication system in the seventh example mode 560 comprises a local infrastructure provider network, fixed hotspot access network, end-user devices, and environment devices.

As shown in FIG. 5C, and in FIG. 1 in more detail, the local infrastructure provider network may be communicatively coupled to any or all of the other elements present in the seventh example mode 560 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary.

Also, though not explicitly shown, the local infrastructure provider network may be communicatively coupled to any or all of the other elements present in the seventh example mode 560 (or configuration) via one or more wireless links (e.g., RF link, non-tethered optical link, etc.). For example, the local infrastructure provider network may be communicatively coupled to the fixed hotspot access network (or any component thereof), the end-user devices, and/or environment devices via one or more wireless links. Note that the communication link shown in the seventh example mode 560 of FIG. 5C between the local infrastructure provider network and the fixed hotspot access network may be wired and/or wireless.

The fixed hotspot access network is also shown in the seventh example mode 560 to be communicatively coupled to the end-user devices and/or environment devices via one or more wireless links. Many examples of such wireless coupling are provided herein. Additionally, the end-user devices are also shown in the seventh example mode 560 to be communicatively coupled to the environment devices via one or more wireless links. Many examples of such wireless coupling are provided herein.

In the seventh example mode 560 (e.g., the no backbone and mobile hotspots available mode), information (or data) may be communicated between an end-user device and a server via the fixed hotspot access network and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network (e.g., skipping the fixed hotspot access network).

Similarly, in the seventh example mode 560 (e.g., the no backbone and mobile hotspots available mode), information (or data) may be communicated between an environment device and a server via the fixed hotspot access network and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the local infrastructure provider network (e.g., skipping the fixed hotspot access network).

The seventh example mode 560 may be utilized for any of a variety of reasons, non-limiting examples of which are provided herein. In an example controlled space implementation, Cloud access might not be provided (e.g., for security reasons, privacy reasons, etc.), and full (or sufficient) coverage of the coverage area is provided by the fixed hotspot access network, and thus the mobile hotspot access network is not needed. For example, the end-user devices and environment devices may communicate directly (e.g., via Ethernet, Wi-Fi, etc.) with the Fixed APs

Note also that the seventh example mode 560 may be utilized in a scenario in which the backbone provider network and/or fixed hotspot access network are normally available but are currently unavailable (e.g., due to equipment failure, due to communication link failure, due to power outage, due to a temporary denial of service, etc.).

The eighth example mode (or configuration) 570 (e.g., the no backbone, fixed hotspots, and local infrastructure available mode) may, for example, share any or all characteristics with the first example mode 500, albeit without the backbone provider network, local infrastructure provider network, fixed hotspot access network, and communication links therewith. For example, the communication system in the eighth example mode 570 comprises a mobile hotspot access network, end-user devices, and environment devices.

As shown in FIG. 5C, and in FIG. 1 in more detail, the mobile hotspot access network is shown in the eighth example mode 570 to be communicatively coupled to the end-user devices and/or environment devices via one or more wireless links. Many examples of such wireless coupling are provided herein. Further, the end-user devices are also shown in the eighth example mode 570 to be communicatively coupled to the environment devices via one or more wireless links. Many examples of such wireless coupling are provided herein.

In the eighth example mode 570 (e.g., the no backbone, fixed hotspots, and local infrastructure available mode), information (or data) might not (at least currently) be communicated between an end-user device and a server (e.g., a coupled to the backbone provider network, local infrastructure provider network, etc.). Similarly, information (or data) might not (at least currently) be communicated between an environment device and a server (e.g., a coupled to the backbone provider network, local infrastructure provider network, etc.). Note that the environment device may communicate with or through an end-user device (e.g., instead of or in addition to the mobile hotspot access network).

The eighth example mode 570 may be utilized for any of a variety of reasons, non-limiting examples of which are provided herein. In an example implementation, the eighth example mode 570 may be utilized for gathering and/or serving data (e.g., in a delay-tolerant networking scenario), providing peer-to-peer communication through the mobile hotspot access network (e.g., between clients of a single Mobile AP, between clients of respective different Mobile APs, etc.), etc. In another example scenario, the eighth example mode 570 may be utilized in a scenario in which vehicle-to-vehicle communications are prioritized above vehicle-to-infrastructure communications. In yet another example scenario, the eighth example mode 570 may be utilized in a scenario in which all infrastructure access is lost (e.g., in tunnels, parking garages, etc.).

Note also that the eighth example mode 570 may be utilized in a scenario in which the backbone provider network, local infrastructure provider network, and/or fixed hotspot access network are normally available but are currently unavailable (e.g., due to equipment failure, due to communication link failure, due to power outage, due to a temporary denial of service, etc.).

As shown and discussed herein, it is beneficial to have a generic platform that allows multi-mode communications of multiple users or machines within different environments, using multiple devices with multiple technologies, connected to multiple moving/static things with multiple technologies, forming wireless (mesh) hotspot networks over different environments, connected to multiple wired/wireless infrastructure/network backbone providers, ultimately connected to the Internet, Cloud or private network infrastructure.

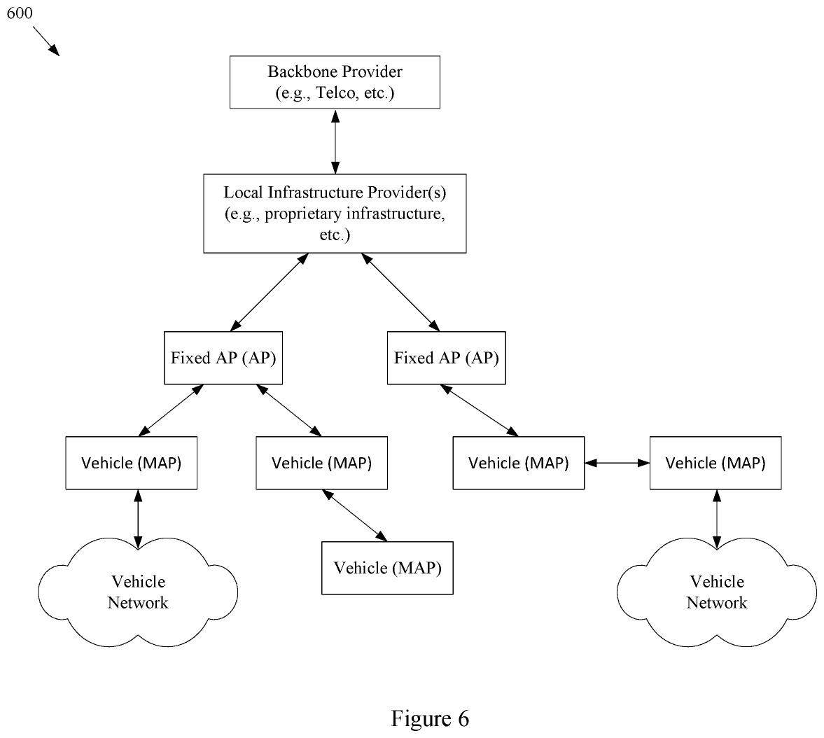

FIG. 6 shows yet another block diagram of an example network configuration, in accordance with various aspects of the present disclosure. The example network 600 may, for example, share any or all characteristics with the other example methods, systems, networks and/or network components 100, 200, 300, 400, and 500-570, discussed herein. Notably, the example network 600 shows a plurality of Mobile APs (or OBUs), each communicatively coupled to a Fixed AP (or RSU), where each Mobile AP may provide network access to a vehicle network (e.g., comprising other vehicles or vehicle networks, user devices, sensor devices, etc.).

In accordance with various aspects of the present disclosure, systems and methods are provided that manage a vehicle communication network, for example in accordance with the location of nodes and end devices, in a way that provides for stable TCP/IP Internet access, among other things. For example, an end user may be provided with a clean and stable Wi-Fi Internet connection that may appear to the end user to be the same as the Wi-Fi Internet connection at the user's home, user's workplace, fixed public Wi-Fi hotspots, etc. For example, for a user utilizing a communication network as described herein, a TCP session may stay active, downloads may process normally, calls may proceed without interruption, etc. As discussed herein, a vehicle communication network in accordance with various aspects of this disclosure may be applied as a transport layer for regular Internet traffic and/or for private network traffic (e.g., extending the access of customer private LANs from the wired network to vehicles and users around them, etc.).

In accordance with an example network implementation, although a user might be always connected to a single Wi-Fi AP of a vehicle, the vehicle (or the access point thereof, for example a MAP) is moving between multiple access points (e.g., FAPs, other MAPs, cellular base stations, fixed Wi-Fi hotspots, etc.). For example, mobility management implemented in accordance with various aspects of the present disclosure supports the mobility of each vehicle and its users across different communication technologies (e.g., 802.11p, cellular, Wi-Fi, etc.) as the MAPs migrate among FAPs (and/or MAPs) and/or as users migrate between MAPs.

In accordance with various aspects of the present disclosure, a mobility controller (MC), which may also be referred to as an LMA or Network Controller, may monitor the location (e.g., network location, etc.) of various nodes (e.g., MAPs, etc.) and/or the location of end users connected through them. The mobility controller (MC) may, for example, provide seamless handovers (e.g., maintaining communication session continuity) between different access points and/or different technologies with low link latency and low handover times.

The architecture provided herein is scalable, for example taking advantage of redundant elements and/or functionality to provide load-balancing of control and/or data communication functionality, as well as to decrease failure probability. Various aspects of the present disclosure also provide for decreased control signaling (e.g., in amount and/or frequency), which reduces the control overhead and reduces the size of control tables and tunneling, for example both in backend servers and in APs (e.g., FAPs and/or MAPs).

Additionally, a communication network (or components thereof) in accordance with various aspects of this disclosure may comprise the ability to interact with mobile devices in order to control some or all of their connection choices and/or to leverage their control functionality. For example, in an example implementation, a mobile application can run in the background, managing the available networks and/or nodes thereof and selecting the one that best fits, and then triggering a handoff to the selected network (or node thereof) before breakdown of the current connection.

The communication network (or components thereof) is also configurable, according to the infrastructure requirements and/or mobility needs of each client, etc. For example, the communication network (or components thereof) may comprise the capability to support different Layer 2 (L2) or Layer 3 (L3) implementations, or combinations thereof, as well as IPv4/IPv6 traffic.

A wireless network comprising nodes in vehicles and nodes that are at fixed physical locations, which is referred to herein as an Internet of Moving Things, seeks to realize the potential of millions of connected vehicles worldwide by adding more utility to each vehicle through the use of vehicle-to-vehicle (V2V) and/or vehicle-to-infrastructure (V2I) communication, sometimes represented collectively as “V2X,” using a mesh network. Again it should be understood that a vehicle refers to autonomous vehicles as well as non-autonomous vehicles.

Urban mobility is shifting towards a mobility-as-a-service (MaaS) paradigm that may be supported by, for example, fleets of autonomous driving vehicles. This paradigm shift to driverless, connected vehicles will change the commuting experience for customer/end-users and at its core supports ubiquitous Internet connectivity provided by network and service providers.

Network and service providers in such an arrangement may design and control a key customer-service interaction moment: a “splash screen” or “splash page” of what is referred to herein as a “captive portal.” The terms “splash screen”/“splash page” are used herein to refer to an initial screen or web page delivered to an electronic device of a customer/end-user upon establishing a connection with a web server, while the term “captive portal” is used herein to refer to a web page that is displayed to newly connected users before they are granted broader access to network resources. Through the use of a captive portal, network and service providers may, for example, augment brand presence, target messages and information directly to the customer, and increase their revenue stream through advertisement.

Advertisements presented via captive portal systems may focus on a revenue model based on the customer/end-user “view” and “click”, which may be measured in what are referred to herein as advertisement “impressions.” The term “impression” in the context of advertising may be defined as the point in time at which an advertisement is viewed once by a customer/end-user/visitor, or displayed once on a web page. Thus, in typical captive portal systems, an impression may be restricted to a single interaction moment, that is, the point in time when the customer/end-user uses an electronic device (e.g., wireless device such as smartphones, laptop computers, tablet computers, e-readers, etc.) to connect to a captive portal system of a service or network and is presented with a splash screen/page of the captive portal system on a display of the electronic device of the customer/end-user.

It has been observed that present day captive portals and their control and management systems do not take full advantage of customer/end-user presence within the service area of a mobile wireless network such as an Internet of Moving Things, or of the added contextual awareness that results from being a part of a vehicle-based wireless mesh network.

A wireless network in accordance with various aspects of the present disclosure may be used to increase network and service provider advertisement revenue by maximizing the number of advertisement impressions through more frequent interactions between the customer and the network or service through the wireless-enabled electronic device(s) of the customer. Such a network includes a control and management system (e.g., in the cloud) for captive portal and advertisement orchestration in a vehicle mesh scenario. A wireless network in accordance with aspects of the present disclosure may include various methods for distributing rules and/or policies by, for example, a cloud-based system to systems in a vehicle mesh including, for example, what are referred to herein as “edge captive portal systems” for advertisement presentation and monetization. Such a network may include various methods for distributing rules and/or policies between the infrastructure (e.g., wireless network fixed access points) and the vehicles carrying nodes of a wireless mesh network, for advertisement presentation and monetization. In addition, a wireless network in accordance with various aspects of the present disclosure may include various decision-making methods for presenting advertisements based on context-aware data available at the edge of a wireless network as described herein (e.g., at a vehicle) such as, by way of example and not limitation, one or more of a physical/geographic location of a vehicle, a time of day, a day of week, an occurrence of a public event, mobility and people patterns, and/or service usage, or other suitable criteria. The rules and/or policies may be referred as, for example, “rules” for the sake of simplicity.

A network according to various aspects of the present disclosure supports improved transportation of data and control information involved in the control and management of captive portal related activities, and provides methods for cost effective peer-to-peer content distribution between the vehicles in the mesh. Such a network leverages best-effort data transmission cost functions in order to reduce service costs, may include methods for caching monetization logs in the mesh for opportunistic asynchronous upload, and may support aspects of a customer device push advertisement notification-based monetization model.

Currently, splash pages/screens and captive portals are limited in the frequency at which they are presented to customers/end-users. Traditionally, these mechanisms are utilized as a first form of contact between customers/end-users with Wi-Fi service of a network and/or service provider, and often require an action from the end-user in order to access the service. Additional information about a Cloud architecture of an example cloud-based captive portal system may be found in, for example, U.S. patent application Ser. No. 15/098,542, titled “Systems and Methods for Interfacing With a Network of Moving Things,” filed Apr. 14, 2016, now U.S. Pat. No. 9,521,606, the complete subject matter of which is hereby incorporated herein by reference, in its entirety. Advertisements (“ads”), which may be displayed on a splash screen of a captive portal, before access to the Wi-Fi service is permitted, are widely used by networks and service providers as a primary source of revenue. The advertisements may be displayed based on rules defined in “advertising campaigns,” also referred to herein a “campaigns,” that may have predetermined durations. User interaction with the advertisements (e.g., view the ad, click on the ad, visit a web page of the advertiser), and the location of the advertisement within the captive portal, influence the “click-through rate,” number of ad “impressions,” the value of the advertisement, and the estimate of the amount of earnings or revenue that may result from the ad.

In a network such as the Internet of Moving Things described herein, customers and users may interact with the network or service as part of traveling during a journey or commute. Limiting the monetization model to the use of splash screens and captive portals only at the beginning of the journey or commute does not take full advantage of the dynamic nature of vehicles, the mesh of a wireless network as described herein, and the infrastructures of a city and of various urban spaces. Furthermore, it is possible that the moment at which the end-user connects to the network or service is not the most valuable point in time or travel at which to present a specific advertisement. More control over the presentation of advertisements may result in high value perception and revenue gains for the network or service providers as well as greater brand exposure for the advertisers.

The new mobile advertisement paradigm afforded by a network such as the Internet of Moving Things described herein leverages context-aware decision making, targeted and personalized messaging to the customer/end-user, and a control and management system able to distribute rules and policies to the network edge (e.g., to fixed and/or mobile access points). Affording autonomous decision-making in regards to when to present the advertisement and content, and when and how to download, store, and offload data is a key objective in shifting intelligence to the edge of the network. Software “background worker/helper” processes may be used to enable push notification services (e.g., the use of Apple Push Notifications (APNs), Google Cloud Messaging (GCM), and World Wide Web Consortium (W3C) standards support for web notifications) from an “edge captive portal system” within a network access point (e.g., a mobile access point (MAP) or an on-board unit (OBU) device installed in a vehicle such as, for example, an automobile, a van, a bus, an autonomous vehicle, etc.).

Such “background worker/helper” processes may, for example, continuously track vehicle position and identify vehicle proximity to one or more “regions of interest” (ROI) for which corresponding advertising campaigns may be active and at which an advertisement should be presented, e.g., to the electronic device of the customer/end, based on various conditions. In accordance with an alternative approach of the present disclosure, the ROI may be used to determine whether a geographic location (e.g., latitude/longitude) reported by an electronic device of a customer/end-user within wireless communication range is in proximity to one or more of the ROIs, and may result in the delivery or activation of advertisements for display by the electronic device of the customer/end-user, based on the geographic location of the customer/end-user not necessarily located with or in a vehicle.

In a network in accordance with aspects of the present disclosure, such various conditions may include, by way of example and not limitation, physical/geographic location (e.g., latitude/longitude, or other identifier of location), vehicle mesh density (e.g., number of vehicles within a particular area or distance, and/or proximity to, neighboring network elements (e.g., MAPs of neighboring vehicles within wireless communication range)). Such various conditions may also include interaction of the MAP/vehicle with relation to “geofences,” that is, geographic regions having a defined boundary (e.g., a polygonal boundary) that may be used to designate a ROI. Such various conditions may also include “temporal conditions” such as a time of day, a day of the week; and conditions such as the occurrence of special events, public holidays, and city events. Information about the presence of a particular number of people at certain physical/geographic location; in a particular vehicle; or wirelessly connected to a particular network or service, and the occurrence or existence of particular people and mobility patterns in the area served may also be used.

In a network or system in accordance with aspects of the present disclosure, the content of advertisements may be displayed as a personalized, rich notification (e.g., an advertisement notification banner) that may, for example, contain a message and an image (e.g., a “thumbnail”) that are pushed to a device of a customer/end-user by a captive portal system. Advertisement notification banners may, for example, be superimposed over all other content on the display of the customer/end-user device or may appear in a lock screen or notification screen of the customer/end-user device, and thus may provide maximized advertisement exposure and impressions. In accordance with various aspects of the present disclosure, expanding the advertisement notification banner may display additional text and may enlarge a thumbnail image. Clicking-on or tapping (e.g., using a mouse or briefly touching a touch-sensitive screen) the advertisement notification banner may open a captive portal application and may display a specific advertisement page with additional content.

Various aspects of the present disclosure may include a monetization model based on a customer/end-user “viewing” an advertisement, “clicking” on an advertisement, and/or “visiting” an advertisement that can be further parameterized, contextualized, and personalized with available data provided by the vehicle mesh. The end-user is considered to have “viewed” an advertisement once the advertisement has been presented or displayed to the end-user (i.e., once the advertisement has been shown on the end-user device). This may also be referred to as an end-user “impression” or “ad view.” Following presentation or display of an advertisement to an end-user, the end-user may “click” on the advertisement, which may be tracked (e.g., counted) and may result in the end-user “viewing” (i.e., being presented) additional information about that advertisement or being re-directed to a specific webpage that displays additional information for that advertisement. An end-user is considered to have “visited” an advertisement when the end-user has “viewed” an advertisement, has “clicked” on the advertisement, and the end-user was then taken to a specific web page that displays additional advertisement information. Certain conditions allow advertisers to further expose their brand, their message, and further product awareness and are considered “premium” advertisement. A captive portal system in accordance with aspects of the present disclosure, running in a MAP, present in a vehicle, may orchestrate some or all local decisions, and may push content to customer/end-user devices, and may perform accounting for advertisement tracking. Concurrently, the captive portal system may be actively updating advertising campaign rules, policies, and/or content as well as offloading collected data for further processing and determination of earnings estimates for advertisements. A cloud-based control and management system in accordance with aspects of the present disclosure allows for configuration and parameterization of edge captive portals and advertising campaigns based on the data available from a vehicle mesh.

Edge captive portal systems in accordance with aspects of the present disclosure may be published or updated using real-time or best-effort (e.g., delay tolerant) delivery means. Additional information about the use of various real-time and best-effort (i.e., delay-tolerant) communication mechanisms may be found, for example, in U.S. patent application Ser. No. 15/353,966, titled “Systems and Method for Delay Tolerant Networking in a Network of Moving Things, for Example Including a Network of Autonomous Vehicles,” now U.S. Pat. No. 9,693,297, the complete subject matter of which is hereby incorporated herein by reference, in its entirety. The choice of such delivery options has a direct impact on the cost of sending content and data to the edge devices, as the edge device may use a more or less cost effective wireless network to receive the data. In addition, monitoring of the edge captive portal systems and current advertising campaign analytics, and data offload from the edge device may also be configured to use real-time or best-effort communication mechanisms, which may also impact the cost-effectiveness of these data transfers.

In embodiments according to aspects of the present disclosure, control and management, and contextual distributed decision making, are two founding principles that may drive the advertisement monetization model. In such a system, global rules and policies may be defined in the Cloud and shared with the edge systems (e.g., edge captive portal systems), and advertisement campaigns may be defined in the Cloud and may leverage the additional available context to further specify, customize, and personalize the captive portal and advertisements. In addition, edge captive portal systems may leverage additional vehicle mesh data for a more targeted advertisement, and may leverage higher contextual-awareness to enable more informed and autonomous decision-making. A system in accordance with various aspects of the present disclosure may push advertisement notification banners to customer/end-user devices, thereby resulting in an increase in the frequency and amount of exposure of the end-user to advertisement, and a commensurate increase in revenue throughout the customer/end-user journey.

A system in accordance with aspects of the present disclosure may employ best-effort (e.g., delay tolerant) data offload mechanisms that reduce the cost of transferring data (and content) to and from the Cloud, by leveraging a vehicle mesh and infrastructure. The edge captive portal system may consider an end-user journey from the moment an electronic device of a customer/end-user connects to the service, to the moment he/she disconnects the customer/end-user device from the service. During the intervening time period, the customer/end-user device may interact with the service in various ways including, for example, the customer/end-user device may discover and register with a Wi-Fi service and may be presented with a captive portal having advertisements. Additional information about aspects of these interactions may be found in, for example, U.S. patent application Ser. No. 15/098,542 titled “Systems and Methods for Interfacing With a Network of Moving Things,” now U.S. Pat. No. 9,521,606, the complete subject matter of which is hereby incorporated herein, by reference, in its entirety. The customer/end-user device may then be presented with contextual advertisement notification banners, as further described below.

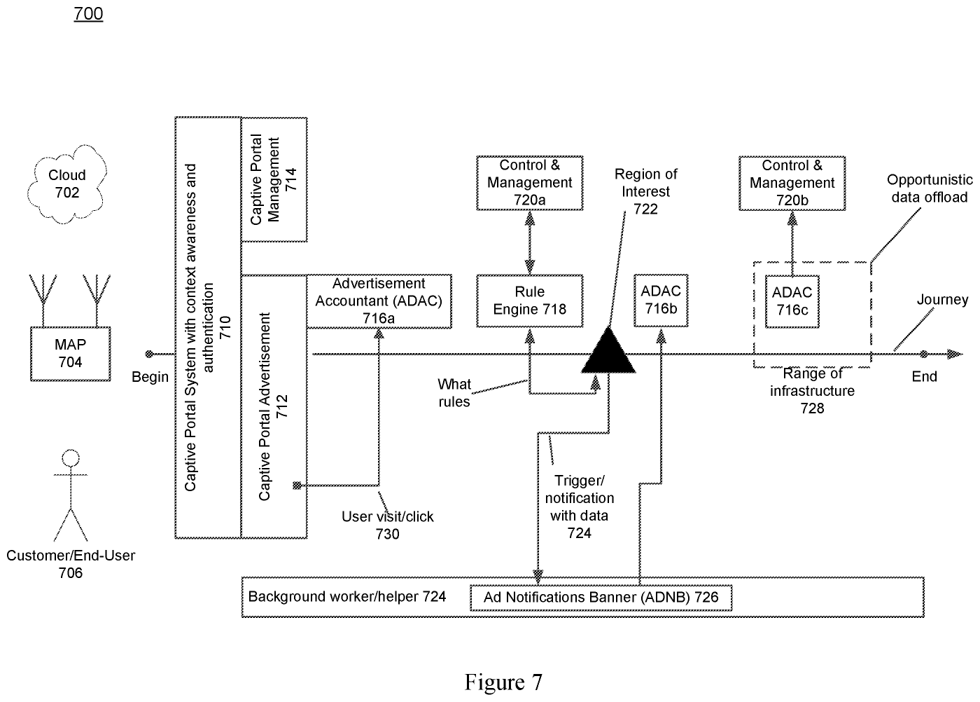

FIG. 7 is an illustration of an example journey of a customer/end-user involving an edge captive portal system 710, in accordance with various aspects of the present disclosure. In such a system, rules and policies used to define and specify the interaction between the customer/end-user and a service may be managed and controlled at the Cloud 702. The edge captive portal system 710 running in a MAP 704 of a vehicle (e.g., an automobile, taxi, van, truck, bus, train, boat/ship, or autonomous vehicle) may use such rules and policies, along with additional contextual data provided by the vehicles of a vehicle mesh as described herein, to decide what advertisement(s) to present to the wireless enabled electronic devices of customers/end-users 706. The example of FIG. 7 is an illustration of a journey of a customer/end-user from the moment the customer/end-user enters the vehicle (i.e., at “begin”), connects to the available network or service (e.g., via the MAP 704), and is presented with a splash page or screen of the captive portal system 710 supported by the MAP 704, along with one or more advertisements (e.g., captive portal advertisement 712).

In accordance with aspects of the present disclosure, the customer/end-user 706, throughout a journey such as the example of FIG. 7, may be presented with push advertisement (ad) notification banners, when certain captive portal advertisement campaign criteria are met. The example illustrated in FIG. 7 ends (e.g., at “end”) when the customer/end-user 706 exits the vehicle and is out of range of the MAP 704 providing to the customer/end-user 706 device wireless access to the network(s) or service(s) available through the MAP 704. At the moment the splash page of the captive portal system 710 is sent to the electronic device of the customer/end-user 706 for display to a customer/end-user 706, software code of a worker/helper background process 724 is instantiated, allowing the captive portal system 710 to push advertisement notification banner(s) 726 to the electronic device of the customer/end-user 706. Such advertisement notification banners 726 may, for example, be based when one or more region of interest (ROI) 722 triggers 724, and may overlay other content that may already be on the display of the electronic device of the customer/end-user 706 at that moment.

In accordance with aspects of the present disclosure, functionality of the captive portal system 710 referred to herein as an “Advertisement Accountant” (ADAC), represented in FIG. 7 as instances of ADACs 716a, 716b, 716c, may locally register customer/end-user interactions with displayed advertisements, including interactions with the pushed advertisement notification banners 726, and may later, e.g., within a wireless range of the infrastructure 728 of the network, offload data representative of those interactions to, for example, the Cloud 702, depending on a particular data transfer policy (e.g., best-effort, opportunistic, critical) that is currently defined for the MAP 704 and/or the push advertisement notification banner 726 with which the customer/end-user interacted.

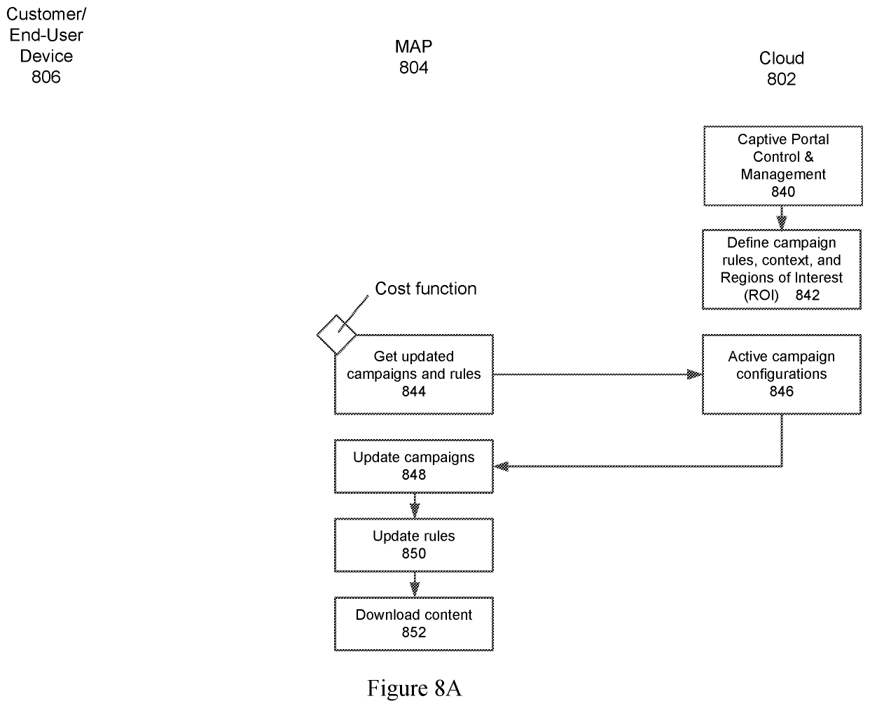

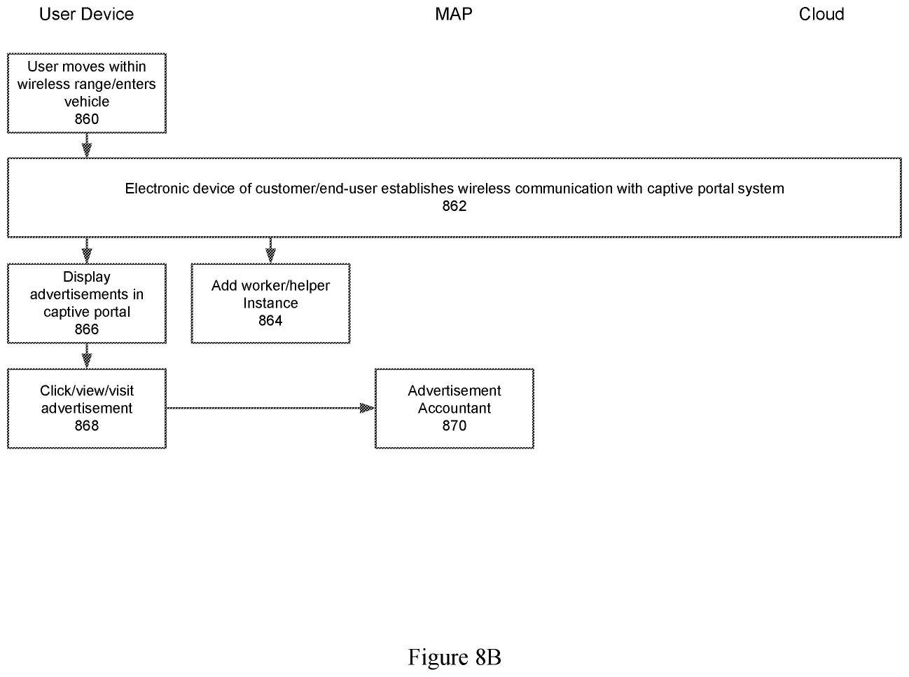

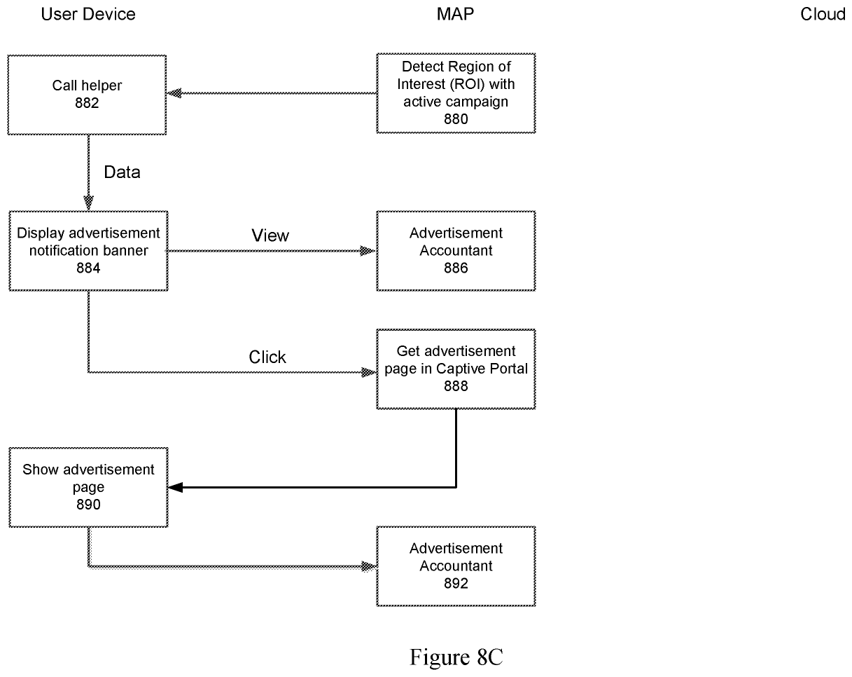

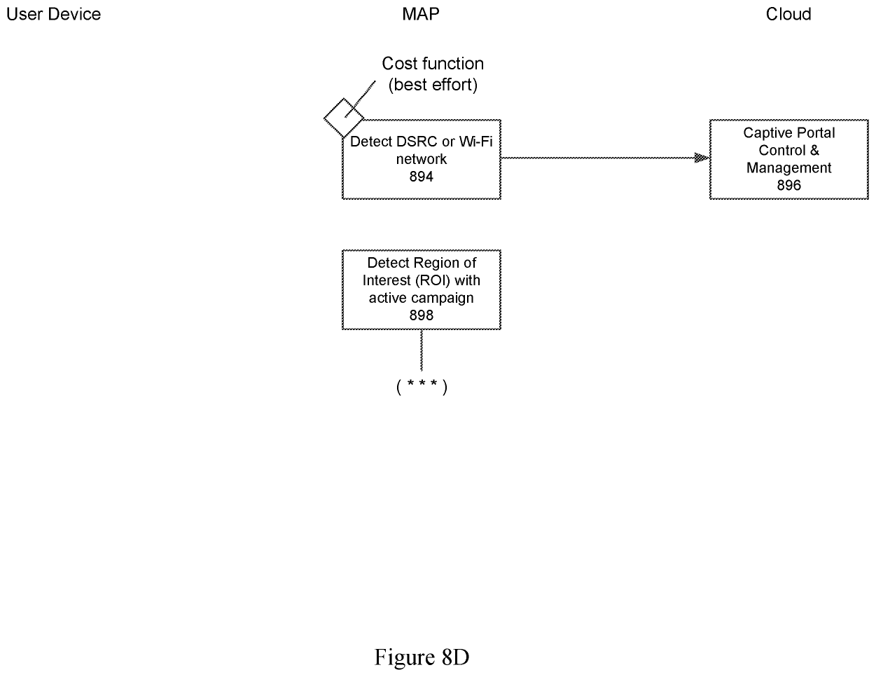

FIGS. 8A-8D illustrate an example of how three components, a captive portal control and management functionality 802, an edge captive portal system in a MAP 804 such as the example illustrated in FIG. 7 as the captive portal system 710, and an electronic device of a customer/end-user 806, may interact in order to extract maximum value from a wireless vehicle mesh network to monetize network or service usage through advertisements, in accordance with various aspects of the present disclosure.

As illustrated in the example of FIG. 8A, at block 840, a Cloud-based captive portal control and management system may enable the creation of, for example at block 842, advertising campaigns and advertisements, as well as the definition of rules for the presentation of advertising campaigns and advertisements to customers/end-users including, for example, information that defines “regions of interest” such as one or more “geofences” within/outside which advertisement(s) of a campaign are to be displayed; and information that defines when advertisements of a campaign (e.g., time of day, day of week, etc.) are to be presented to a customer/end-user. Such a system may also enable creation of information that specifies conditions that, when met, trigger display of advertisement(s) including, for example, “people patterns” and other conditions; and the creation of policies that define a data transfer mechanism to be used (e.g., best-effort, opportunistic, critical, etc.). A “people pattern” may, for example, by characterized by information representing a number of people, a geographic/physical location at which the people are located, whether the people are in a vehicle serviced by the captive portal, and whether the people are connected to a service provided by the captive portal.

At block 844, the MAP 804, may access updated advertising campaign and/or rule and policy update information from the Cloud 802 that may, at block 846, define and maintain information representative of active advertising campaigns configurations. The updated information may be sent to the MAP 804 using a communication mechanism that delivers the updated information immediately, for example via a relatively more expensive cellular infrastructure path. Alternatively, the updated information may be conveyed via a relatively less expensive, when-available/best-effort path, and such information may take effect at a time depending on the data transfer policy in use, which may occur, for example, when the MAP 804 is in wireless communication range of another vehicle (i.e., via a vehicle-to-vehicle (V2V) link), in wireless communication range of one or more fixed access points of the infrastructure (i.e., via a vehicle-to-infrastructure (V2I) link), and/or via a Wi-Fi wireless network. The edge captive portal system of the MAP 804 may manage the data transfer decision based upon the policies and rules in effect, and may, at blocks 848, 850, 852, update information for captive portal content for display or operation, advertising campaign information, and advertisements, accordingly.

In a system in accordance with various aspects of the present disclosure, a customer/end-user may, as shown at block 860 of FIG. 8B, move within wireless communication range of a MAP (e.g., come into proximity of or enter a vehicle that is equipped with a MAP), and the electronic device of the customer/end-user device may establish wireless communication with the MAP having a captive portal system using a Wi-Fi service/network provided by the MAP. As illustrated at block 862, the electronic device of the customer/end-user may then be presented with a splash screen/page of the captive portal of the MAP. Additional information about the interaction of the customer/end-user device with the captive portal system may be found, for example, in U.S. patent application Ser. No. 15/098,542, titled “Systems and Methods for Interfacing With a Network of Moving Things,” filed on Apr. 14, 2016, now U.S. Pat. No. 9,521,606, the complete subject matter of which is hereby incorporated herein by reference, in its entirety.

After communication between the electronic device and the edge captive portal system has been established and the initial or splash screen/page has been delivered to the electronic device of the customer/end-user, the captive portal system may, at block 864, cause the electronic device of the customer/end-user to instantiate a software process referred to herein as a “worker/helper.” The worker/helper process may, for example, run as a “background process,” and may enable the edge captive portal system to push advertisement notification banners to the electronic device of the customer/end-user for as long as the customer/end-user is wirelessly connected to the service/network supported by the MAP.

As the electronic device of the customer/end-user moves about the area served by the network of moving things (e.g., the vehicle carrying the customer/end-user roams throughout the streets, highways, routes, etc.), the MAP and the edge captive portal system may monitor the geographic position (e.g., latitude/longitude) of the vehicle in relation to one or more regions of interest (ROI) that may be defined by a cloud-based, captive portal and advertisement control and management system. During the journey of the customer/end-user, the edge captive portal system of a MAP may, e.g., as shown at block 866, use various rules and available contextual data such as, for example, geographic location (e.g., latitude/longitude), time-of-day, people patterns, special events, etc., to present various advertisements to the electronic device of the customer/end-user.

In accordance with aspects of the present disclosure, customer/end-user interactions and impressions in response to such advertisements including, by way of example and not limitation, “views,” “clicks,” and “visits” may, as represented as block 868 of FIG. 8B, be detected and recorded in the edge captive portal system of the present disclosure, for later transfer to and storage at what is referred to herein as an “advertisement accountant,” which may be located at a cloud-based system, as illustrated in the example at block 870 of FIG. 8B. The edge captive portal system may then, based on defined data transfer policies (e.g., best-effort, opportunistic, critical, etc.) provided by the cloud-based system, upload various information to the cloud-based system. Such uploaded information may include, for example, information representative of customer/end-user interactions and impressions when viewing particular advertisements, and information that identifies the advertisements displayed to the customer/end-user at or about the time the customer/end-user interactions and impressions occurred. Such information representative of customer/end-user interactions and impressions may be detected by, for example, the edge captive portal system of the electronic device of the customer/end-user and forwarded to the cloud-based system for use in overall tracking of customer/end-user behavior, which may include the calculation of advertisement and/or edge captive portal system accounting and earnings estimates.

As mentioned above, an edge captive portal system in accordance with various aspects of the present disclosure may receive information that defines one or more regions of interest (ROI) and information identifying corresponding advertisements for display from, for example, a cloud based system (e.g., a captive portal control and management system as discussed herein) that is communicatively coupled to the edge captive portal system via the network of moving things of the present disclosure. FIG. 8C shows an example interaction between a customer/end-user and an edge captive portal system of, for example, a MAP of a vehicle equipped to provide a wireless access point (AP) of a local wireless area network (WLAN) supported by the MAP. At block 880 of the interaction of FIG. 8C, the edge captive portal system, or functionality of the MAP on which the edge captive portal system is installed and running, may detect that the geographic location (e.g., latitude/longitude) of the MAP or the electronic device of the customer/end-user is in a particular relationship with a predefined ROI.

The particular relationship and various characteristics of an ROI may be provided to the edge captive portal system or MAP by, for example, a cloud-based system as discussed with respect to the present disclosure. The particular relationship may be, for example, a condition that the electronic device of the customer/end-user or the MAP is within or outside a geographic boundary such as a geofence, or that the electronic device of the customer/end-user or the MAP is within a certain physical distance of an identified geographic location (e.g., latitude/longitude) or physical feature (e.g., roadway, body of water/waterway train route, building, stadium, etc.) of a geographic region served by the network of moving things of the present disclosure. The various characteristics of an ROI may, for example, comprise information representative of advertisements to be displayed when the particular relationship of the ROI is met, e.g., a time-of-day, day-of-week, or other time period when the ROI is enable or can be activated, or other conditions. An ROI may be referred to as “active” when the particular relationship and conditions of the ROI are met or occur.

Upon detection, at block 880, that the geographic location of the MAP or the electronic device of the customer/end-user is in a particular relationship with a predefined ROI, the MAP may send a trigger to the electronic device of the customer/end-user that may, at block 882, respond by causing execution of the “worker/helper” process discussed above. The worker/helper process may then, using data related to the ROI (e.g., information representative of an advertisement for the ROI), cause, at block 884, display of what is referred to herein as an “advertisement notification banner.” The display of an advertisement notification banner may comprise making visible, a graphical image of an advertisement that overlays some or all of the information that had been visible/was being viewed on the display screen of the electronic device of the customer/end-user prior to the display of the advertisement notification banner. Upon display of the advertisement notification banner on the screen of the electronic device of the customer/end-user, a notification of the occurrence of a “view” of the advertisement notification banner may then be sent by the electronic device of the customer/end-user to the advertisement accountant of the MAP, at block 886.

If, at some later point in time, the customer/end-user “clicks” upon the advertisement notification banner displayed on the display screen of their electronic device, the electronic device of the customer/end-user may send notification of the clicking-on/selection of the advertisement notification banner and may, at block 888, access additional information representative of one or more related advertisement page(s), which may comprise, for example, more detailed graphical image(s), one or more end-user-selectable graphical objects, and/or other information content displayable on the electronic device of the customer/end-user and that is related to the advertisement notification banner. The MAP may then send the information representative of the one or more related advertisement page(s) to the electronic device of the customer/end-user that may, at block 890, show the one or more related advertisement page(s) to the customer/end-user. The electronic device of the customer/end-user may then send notification of the display by the customer/end-user of the one or more related advertisement page(s), to the advertisement accountant of the MAP, at block 892, for storage, later processing, and/or transmission to the cloud-based system.

At a later point in time, one or more of the wireless (e.g., radio frequency (RF)) communication interfaces of the MAP of the present disclosure may detect that the MAP is within wireless communication range of one or more other elements of the network of moving things as described herein (e.g., a mobile or fixed access point equipped for DSRC/Wi-Fi communication) or a base station/cell site element of a cellular infrastructure, and may, at block 894 of FIG. 8D, establish communication with and transfer various information to/from the MAP from/to functionality of a captive portal control and management system, such as that shown at block 896 of FIG. 8D, of a cloud based system such as the captive portal control and management system discussed hereinabove. As detailed above, a cloud-based system having captive portal control and management functionality may, for example, provide to elements of a network of moving things according to various aspects of the present disclosure, various advertising-related content, rules, ROI characteristics, etc., and may receive, track, store, analyze, and/or perform accounting related to customer/end-user behavior in regards to various advertisements delivered to the electronic device of the customer/end-user including, for example, advertisement notification banners.

Following wireless transfer of information between the MAP and other elements of the network of moving things, the MAP operating on an electronic device of the customer/end-user of the present example may, at block 898, return to detecting whether the MAP has at least one ROI having at least one corresponding active advertisement campaign, and in response to such detection, taking the actions described above.

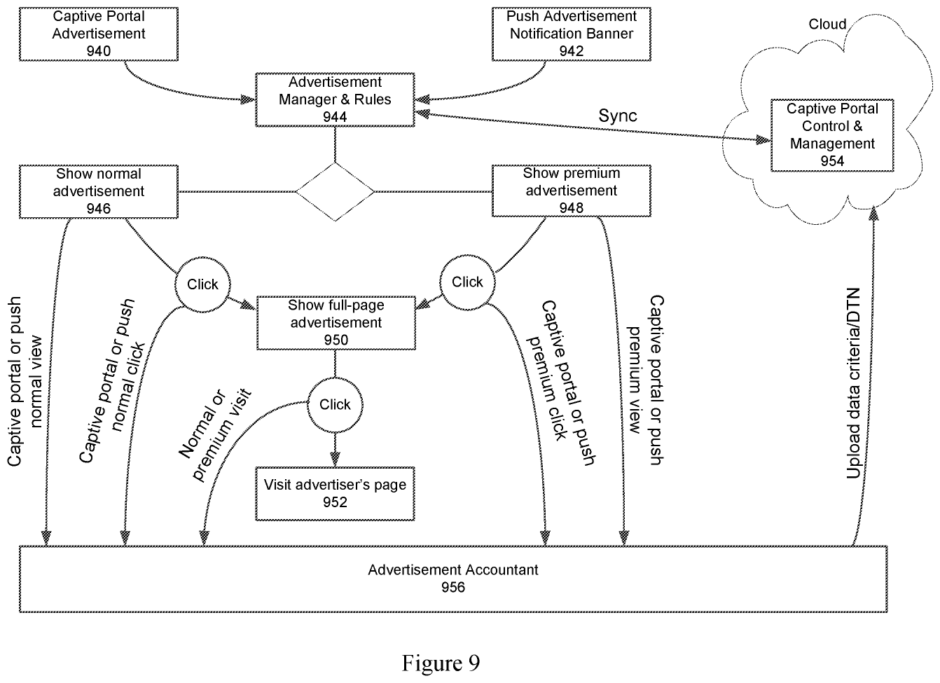

FIG. 9 illustrates an example monetization model for an edge captive portal system using push advertisement notification banners based on two example advertisement categories referred to herein as “normal” and “premium,” in accordance with various aspects of the present disclosure. Various advertisements may compete for customer/end-user attention, and the edge captive portal system may determine which advertisement(s) to present to each customer/end-user based not only on context information provided by the vehicle mesh, but also based on one or more rules that may be defined in or by, for example, a cloud-based captive portal control and management system.

An edge captive portal system in accordance with various aspects of the present disclosure may use information that represents respective customer/end-user patterns that identify, for example, the type(s) of advertisements on which particular customers/end-users of a respective electronic device click (i.e., select) the most, to then select and present advertisements to each particular customer/end-user according to respective customer/end-user patterns. The advertisements referred to herein as “premium” advertisements may differ from the advertisements referred to herein a “normal” advertisements in that the “premium” advertisements may be presented to the customer/end-user on the electronic device of the customer/end-user as persistent advertisement notification banners that require the customer/end-user to “dismiss” or “view” the advertisement notification banner and that have presentation precedence over “normal” advertisements. “Normal” advertisements may be temporary advertisement notification banners that are displayed on the end-user device and that may automatically dismiss themselves (i.e., disappear) after some period of time, which may be device, operating system, or configuration specific. Advertisements defined as “premium” may require specific contextual information to increase their reach and effectiveness such as, for example, geo-location information (e.g., latitude/longitude); date and/or time of day information; vehicle (e.g., bus) route information; etc.

In a captive portal system according to various aspects of the present disclosure, such advertisements may be presented on the captive portal during the process of an end-user connecting to the network(s) and/or service(s) provided by the captive portal system. In accordance with aspects of the present disclosure, “push” advertisement notification banners may comprise advertisements that are sent to/presented (e.g., displayed) on an end-user device upon occurrence of a trigger such as, for example, a vehicle moving within a geo-fence for which an advertising campaign is currently active. Such advertisements may be presented, for example, after the end-user has connected to a Wi-Fi service and has left the captive portal. This mechanism allows for the presentation of such advertisements during the end-user's normal interaction with the device and service.

In accordance with various aspects of the present disclosure, different types of advertisements and their respective cost per impression differ depending upon, for example, whether the advertisement is presented in a splash screen/page of the edge captive portal or is presented in an advertisement notification banner, whether the advertisement is presented as a “normal” advertisement or a “premium” advertisement, and/or whether the impression is a “view,” in which case the advertisement is presented to the customer/end-user; is a “click,” in which case the customer/end-user may click on/select the advertisement and view the full-screen advertisement; or is a “visit,” in which case the customer/end-user may click on a link to an advertiser's webpage that presents a full-screen advertisement. In accordance with aspects of the present disclosure, impressions may be registered and stored in an “advertisement accountant” of the edge captive portal system, as described herein.

In a system according to aspects of the present disclosure, a local application program interface (API) may permit a background worker/helper process as described herein to specify, by way of example and not limitation, a type of advertisement to be presented, such as “normal” or “premium”; and a source of the advertisement to be presented, such as a captive portal advertisement or a push advertisement notification banner. The local API may also permit the worker/helper process to specify, for example, a type of impression to be record/tracked/monitored such as a view, click, or visit; and information that identifies the advertisement to be presented. In addition, the local API may permit the worker/helper process to specify a timestamp of presentation of the advertisement, and a timestamp of the “click” and “visit” impressions. Such an API may be accessed by the network element that defines the captive portal or that pushes the captive portal to the network, and the API may be supported locally (e.g., by functionality in a mobile AP) or by functionality of a Cloud-based system.

A system that performs the functionality of an “advertisement accountant” in accordance with various aspects of the present disclosure may store relevant contextual information that is later reported to a cloud-based captive portal control and management system to enable, for example, the definition of better/more effective rules and policies. Such contextual information may include, by way of example and not limitation, information representing date and time of events; context data of the MAP and neighbors (e.g., network elements within wireless communication range of the MAP); a quantity of electronic devices of customers/end-users located within wireless communication range of the MAP (e.g., those electronic devices carried on the vehicle of the MAP or within wireless communication range of the MAP); a quantity of electronic devices currently connected to the service/network; a quantity of “active” devices (e.g., the number of devices currently connected to the service); and information representative of people patterns.

As illustrated in the example of FIG. 9, the model for a captive portal and push advertisement monetization system according to aspects of the present disclosure may include functionality of an advertisement manager and rules repository 944 that accepts information representative of one or more captive portal advertisements 940 and information representative of one or more push advertisement notification banners, for presentation to electronic devices of customers/end-users by edge captive portals according to the present disclosure. The advertisement manager and rules repository 944 may be updated from a cloud based system functioning as a captive portal control and management entity 954. In accordance with various aspects of the present disclosure, the functionality of the advertisement manager and rules repository 944 may direct the edge captive portal system to perform functionality to show a “normal” advertisement 946, or to perform functionality to show a “premium” advertisement 948, based upon the context of the edge captive portal system (e.g., vehicle context, wireless context, rules, policies, etc.).

If the advertisement manager and rules repository 944 directed the edge captive portal system to perform functionality to show a “normal” advertisement, the edge captive portal system may cause a notification to the functionality of an advertisement accountant 956 of the occurrence of a captive portal advertisement or push advertisement notification banner normal “view” event. If, at some point in time during which the “normal” captive portal advertisement or “normal” push advertisement notification banner is displayed, the customer/end-user “clicks on” (e.g., selects) the “normal” advertisement, the edge captive portal system may cause a notification to the functionality of the advertisement accountant of the occurrence of a captive portal advertisement or push advertisement notification banner normal “click” event, and the customer/end-user act of “clicking on” (e.g., selecting) may also cause the edge captive portal system to show a full-page/screen advertisement 950 that corresponds to the “normal” advertisement. If the customer/end-user then “clicks on” (e.g., selects) the full-page/screen advertisement, the edge captive portal system may cause a notification to the functionality of the advertisement accountant of the occurrence of a normal “visit” event, and may cause a visit or entry at the advertiser's corresponding website page 952.

If the advertisement manager and rules repository 944 directed the edge captive portal system to perform functionality to show a “premium” advertisement 948, the edge captive portal system may cause a notification to the functionality of an advertisement accountant 956 of the occurrence of a captive portal advertisement or push advertisement notification banner premium “view” event. If, at a later point in time during which the “premium” captive portal advertisement or “premium” push advertisement notification banner is displayed, the customer/end-user “clicks on” (e.g., selects) the “premium” advertisement, the edge captive portal system may cause a notification to the functionality of the advertisement accountant of the occurrence of a captive portal advertisement or push advertisement notification banner premium “click” event, and the customer/end-user act of “clicking on” (e.g., selecting) may also cause the edge captive portal system to show a full-page/screen advertisement 950 that corresponds to the “premium” advertisement. If the customer/end-user then “clicks on” (e.g., selects) the full-page/screen advertisement, the edge captive portal system may cause a notification to the functionality of the advertisement accountant of the occurrence of a premium “visit” event, and may cause a visit to or entry at the advertiser's corresponding website page.

As illustrated in the example of FIG. 9, the functionality of the advertisement accountant 956 may deliver/cause delivery of the various notifications recorded/saved/stored at the MAP on which the edge captive portal system resides, to the cloud-based captive portal control and management system 954, for archiving/persistent storage and/or processing.

The various cloud, edge, and end-user electronic device elements of the captive portal system enable the targeted presentation of advertisement information that is more relevant to the customer/end-user, that is presented in a more timely manner, and that may be contextually more related to the geographic location and time-of-day, and that, due to the increased frequency and exposure to the advertisements, is likely to lead to higher revenue generation for the advertisers.

Systems having functionality of the edge captive portal system, the captive portal control and management system, and other systems described herein enable a higher frequency of occurrence and increased exposure of customers to advertisements, thereby increasing network and service provider revenue. Such systems target and personalize mobile advertisements by improving edge captive portal system awareness, and provide network and service providers with a control and management system that supports the configuration and personalization of each edge captive portal system including, for example, defining regions of interest (ROI) (e.g., geofences); temporal conditions for presentation of advertisements; special events involving advertising; customer/end-user service usage; customer/end-user mobility patterns; information representative of the network mesh; information specific to advertising campaigns, etc.

Systems in accordance with various aspects of the present disclosure include functionality that enables an operator to leverage the vehicle mesh to transfer various types of data (e.g., advertising content, rules, and policies) in a cost-effective manner, and leverage data transfer cost functions to automatically tailor data offload policies. Such systems support cloud-based control and management of advertising; distribution of content, rules, and policies through the network infrastructure and vehicle network mesh; and edge processing and autonomous decision-making at the system of the vehicle. Systems according to aspects of the present disclosure provide an updated advertisement monetization and control and earnings tracking model.

Public transportation and mobility service providers that offer a free-to-use Wi-Fi service to customers and passengers need to generate revenue to maintain the service, retain customers, and improve overall service experience. Enabling network and service providers to more easily control and manage their service, while leveraging the vehicle mesh and increasing the frequency and interaction between customers/passengers with the advertisement publishers, may be expected to drive higher revenue. Moving vehicles have the added benefit of dynamically changing the context in which they operate as they move about. The context-aware notification system for captive portals enables a cloud-based system to define and broadcast rules to the vehicles (e.g., edge captive portal systems), and as they pass through regions of interest, (ROI) trigger, based service and user policies, an advertisement notification banner containing a specific tailored advertisement message. The example updated monetization model discussed herein allows for greater configuration and parameterization, driving multiple categories of advertisements (e.g., “normal” and “premium”) having distinct earnings estimates and perceived value. The vehicle mesh and available infrastructure of a network of moving things as described herein provides a best-effort cost function pertaining to data transfer, thus minimizing costs of data transfer to and from each edge captive portal system.

Although the above discussion makes frequent reference to an edge captive portal system in relation to its operation in a MAP of a vehicle (e.g., automobiles, taxis, trucks, vans, buses, trains, boats, autonomous vehicles, etc.), it should be noted that an edge captive portal system according to aspects of the present disclosure may also be present in other elements of a network of moving things including, for example, a network element that is located at a fixed physical location such as, for example, a fixed access point (FAP), a road side unit (RSU), or other network element that may be located in an area traveled by customers/end-users having electronic devices capable of engaging such an edge captive portal system, including those located near/along sidewalks, rivers, parks, bus stops, train stations/terminals, shopping areas, theaters, stadiums, sports centers, and the like.

A system in accordance with various aspects of the present disclosure may support a social media login to leverage customer/end-user profile information as another dimension of personalization for advertisements, and may provide a mechanism for edge captive portal systems to learn from the rules received from a cloud-based system, and to provide feedback on the efficacy of such rules. In addition, a system as described herein may provide methods to close a feedback loop, by communicating information characterizing customer/end-user interactions with the network or service and advertisements from the edge captive portal systems to the cloud, for more informed rules and policies.

A system in accordance with various aspects of the present disclosure may include methods for parameterizing one or more degrees of freedom for individual edge captive portal system decision-making, and may tailor advertisement needs to individual customers/users by extending service connection and usage patterns of electronic devices of customers/end-users. Such a system may employ a mechanism for edge captive portal systems to identify certain (e.g., premium) locations that have high customer/end-user-traffic, based on functionality that is context-aware (e.g., by using geographic location (e.g., latitude/longitude), time-of-day information, day-of-week information, mobility patterns of customers/end-users, etc.) and service usage. A system in accordance with aspects of the present disclosure may also include functionality that detects/identifies customers/end-users that are connected to the Wi-Fi service of a MAP of a vehicle that customers/end-users are inside or outside of, and target specific advertisements to such customers/end-users in an effort to cause interaction of the customer/end-user that is beneficial to the advertiser, e.g., that results in a customer/end-user visit to a physical store of the advertiser, or an on-line purchase of a product of the advertiser.

Accordingly, as can be seen, the various embodiments of the present disclosure may allow the MAP to provide the mobile device all the information for the mobile device to display the banner, the advertisement, and the link to the advertisement page. This information may be provided to the mobile device as needed depending on, for example, the user interaction, all the information may be provided at once to the mobile device for the mobile device to display as needed, or portions of the information may be provided over time. Similarly, the mobile device may provide instances of user interactions such as, for example, “views,” “clicks,” and “visits,” as they happen in real time, the user interactions may be gathered over a period of time, or the user interactions may be gathered for the present advertising party. There may also be various other methods such as gathering user interactions for a period of time where the user interactions may be grouped by the appropriate advertising party, the particular advertisement, etc.

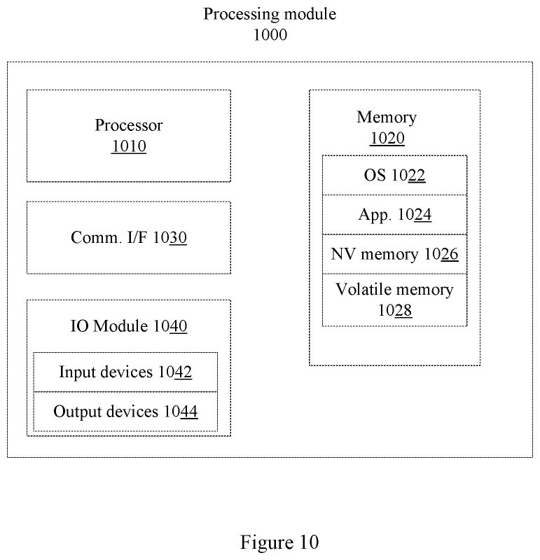

FIG. 10 shows an example block diagram of a processing module for use in an entity, in accordance with various aspects of the present disclosure. Referring to FIG. 10, there is shown a processing module 1000 that may be present in a FAP, a MAP, an AV, a cloud, or any entity or block described in the present disclosure. The processing module 1000 may be used for one or more of the various functionalities described herein.

The processing module 1000 may comprise, for example, a processor 1010, memory 1020, a communication interface 1030, and an TO interface 1040. The processing module 1000 may be used, for example, for processing information in an entity (or server). The processing module 1000 may also operate in concert with one or more other processors that may, for example, control at least a portion of a vehicle and/or assist in the operation of a vehicle. The memory 1020 may include non-volatile memory 1026 and volatile memory 1028. The various entities or nodes may use a part of the memory 1020 to store information and/or instructions. The operating system 1022 and applications 1024 may be stored in, for example, the non-volatile memory 1026, and may be copied to volatile memory 1028 for execution. Various embodiments of the disclosure may use different memory architectures that are design and/or implementation dependent.

The communication interface 1030 may allow the processing module 1000 to communicate with other devices via, for example, a wired protocol such as USB, Ethernet, Firewire, etc., or a wireless protocol such as Bluetooth, Near Field Communication (NFC), Wi-Fi, etc. The various types of radios for communication may be referred to as a transceiver for the sake of simplicity. The communication may also be between/among, for example, one or more entities, system servers, and/or the Cloud.

The processing module 1000 may also comprise the IO module 1040 for communication with a user via the input devices 1042 and output information to be displayed on output devices 1044. The input devices 1042 may comprise, for example, buttons, touch sensitive screen, which may be a part of a display, a microphone, etc. The output devices 1044 may comprise, for example, the display, a speaker, LEDs, etc.

The processor 1010 may operate using different architectures in different embodiments. For example, the processor 1010 may use the memory 1020 to store instructions to execute, or the processor 1010 may have its own memory (not shown) for its instructions. Furthermore, various embodiments may have the processor 1010 work in concert with other processors. For example, if the processing module 1000 is in a vehicle, then the processing module 1000 may work in concert with other processors that may be located in the vehicle. Various embodiments may also allow any of the processors to work individually.

It should be understood that while an example processing module 1000 is described, various embodiments may comprise a portion of the processing module 1000 or more than what is shown in FIG. 10. For example, a processing module 1000 for some server may be limited with respect to input devices 1042 and/or output devices 1044. This may be, for example, because the input/output may be via an external device such as a laptop, a smartphone, a tablet, etc.

Accordingly, it can be seen that the present paper may disclose a method for controlling by a mobile access point (MAP) display of information on a mobile device. This may comprise establishing communication by the MAP with the mobile device. The MAP may provide to the mobile device a party's advertisement to be displayed on the mobile device, additional information for the party's advertisement, and a link to an advertisement page corresponding to the party's advertisement. The MAP may collect from the mobile device user interaction information for transmission to a cloud server for monetization, where the user interaction information comprises one or more of: displaying the party's advertisement, a user selecting the party's advertisement, and the user visiting the advertisement page.

The advertisement may be one of normal advertisement or premium advertisement, where the normal advertisement is a temporary advertisement and the premium advertisement is a persistent advertisement. Rules may be used by the MAP to determine whether to display the normal advertisement or the premium advertisement, where the rules may be received from a server, and the rules may be updated with updates from the server.

The premium advertisement may be displayed based on context information for the mobile device, where the context information may comprise one or more of, for example: physical/geographic location of the MAP; a time of day; a day of week; an occurrence of a public event; mobility patterns of other mobile devices in the neighborhood of the mobile device; and usage by a user of the mobile device of a service provided by a service provider.

The monetization may comprise processing the advertisement information to bill the party for the advertisement. The transmission to the cloud server may be via, for example, a delay tolerant network.

The additional information for the party's advertisement may be provided by the MAP upon receiving a first user interaction from the mobile device, and a link to the advertisement page corresponding to the advertisement may be provided by the MAP upon receiving a second user interaction from the mobile device

Another disclosure of the present paper may be, for example, for a non-transitory machine-readable storage having stored thereon a computer program having at least one code section, where the at least one code section is executable by one or more processors to cause the one or more processors to perform operations comprising establishing communication by the MAP with the mobile device; providing, by the MAP to the mobile device, a party's advertisement to be displayed on the mobile device, additional information for the party's advertisement, and a link to an advertisement page corresponding to the party's advertisement. The one or more processors may collect, by the MAP from the mobile device, user interaction information for transmission to a cloud server for monetization, where the user interaction information comprises one or more of: displaying the party's advertisement, a user selecting the party's advertisement, and the user visiting the advertisement page.

The advertisement may be one of normal advertisement or premium advertisement, where the normal advertisement may be a temporary advertisement and the premium advertisement is a persistent advertisement.

The at least one code section may be executed to cause the one or more processors to perform operations comprising using rules to determine whether to display the normal advertisement or the premium advertisement, where the rules may be received from a server and/or updated with updates from the server. The at least one code section may be executed to display the premium advertisement based on context information for the mobile device. The context information may comprise one or more of, for example, physical/geographic location of the MAP; a time of day; a day of week; an occurrence of a public event; mobility patterns of other mobile devices in the neighborhood of the mobile device; and usage by a user of the mobile device of a service provided by a service provider.

The at least one code section may be executed to cause the one or more processors to perform operations for monetization that comprises processing the advertisement information to bill the party for the advertisement.

The at least one code section may be executed to cause the one or more processors to perform operations comprising transmitting the advertisement information to the cloud server is via a delay tolerant network.

The at least one code section may be executed to cause the one or more processors to perform operations comprising providing the additional information for the party's advertisement upon receiving a first user interaction from the mobile device, and providing a link to the advertisement page corresponding to the advertisement upon receiving a second user interaction from the mobile device.

In accordance with various aspects of this disclosure, examples of the networks and/or components thereof presented herein are provided in U.S. Provisional Application Ser. No. 62/670,989, titled “SYSTEMS AND METHODS FOR CAPTIVE PORTAL CONTROL AND MANAGEMENT IN A NETWORK OF MOVING THINGS,” filed on May 14, 2018, which is hereby incorporated herein by reference in its entirety.

In accordance with various aspects of this disclosure, examples of the networks and/or components thereof presented herein are provided in U.S. Provisional Application Ser. No. 62/222,192, titled “Communication Network of Moving Things,” filed on Sep. 22, 2015, which is hereby incorporated herein by reference in its entirety.

In accordance with various aspects of this disclosure, the networks and/or components thereof presented herein are provided with systems and methods for integrating such networks and/or components with other networks and systems, non-limiting examples of which are provided in U.S. Provisional Application Ser. No. 62/221,997, titled “Integrated Communication Network for A Network of Moving Things,” filed on Sep. 22, 2015, which is hereby incorporated herein by reference in its entirety.

Also, in accordance with various aspects of this disclosure, the networks and/or components thereof presented herein are provided with systems and methods for synchronizing such networks and/or components, non-limiting examples of which are provided in U.S. Provisional Application Ser. No. 62/222,016, titled “Systems and Methods for Synchronizing a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for managing such networks and/or components, non-limiting examples of which are provided in U.S. Provisional Application Ser. No. 62/222,042, titled “Systems and Methods for Managing a Network of Moving Things,” filed on Sep. 22, 2015, which is hereby incorporated herein by reference in its entirety.

Further, in accordance with various aspects of this disclosure, the networks and/or components thereof presented herein are provided with systems and methods for monitoring such networks and/or components, non-limiting examples of which are provided in U.S. Provisional Application Ser. No. 62/222,066, titled “Systems and Methods for Monitoring a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for detecting and/or classifying anomalies in such networks and/or components, non-limiting examples of which are provided in U.S. Provisional Application Ser. No. 62/222,077, titled “Systems and Methods for Detecting and Classifying Anomalies in a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for managing mobility in such networks and/or components, non-limiting examples of which are provided in U.S. Provisional Application Ser. No. 62/222,098, titled “Systems and Methods for Managing Mobility in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for managing connectivity in such networks and/or components, non-limiting examples of which are provided in U.S. Provisional Application Ser. No. 62/222,121, titled “Systems and Methods for Managing Connectivity a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for collecting sensor data in such networks and/or components, non-limiting examples of which are provided in U.S. Provisional Application Ser. No. 62/222,135, titled “Systems and Methods for Collecting Sensor Data in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for interfacing with such networks and/or components, non-limiting examples of which are provided in U.S. Provisional Application Ser. No. 62/222,145, titled “Systems and Methods for Interfacing with a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for interfacing with a user of such networks and/or components, non-limiting examples of which are provided in U.S. Provisional Application Ser. No. 62/222,150, titled “Systems and Methods for Interfacing with a User of a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for data storage and processing in such networks and/or components, non-limiting examples of which are provided in U.S. Provisional Application Ser. No. 62/222,168, titled “Systems and Methods for Data Storage and Processing for a Network of Moving Things,” filed on Sep. 22, 2015, which is hereby incorporated herein by reference in its entirety.

Also, in accordance with various aspects of this disclosure, the networks and/or components thereof presented herein are provided with systems and methods for vehicle traffic management in such networks and/or components, non-limiting examples of which are provided in U.S. Provisional Application Ser. No. 62/222,183, titled “Systems and Methods for Vehicle Traffic Management in a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for environmental management in such networks and/or components, non-limiting examples of which are provided in U.S. Provisional Application Ser. No. 62/222,186, titled “Systems and Methods for Environmental Management in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for managing port or shipping operation in such networks and/or components, non-limiting examples of which are provided in U.S. Provisional Application Ser. No. 62/222,190, titled “Systems and Methods for Port Management in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for enhancing the accuracy of positioning or location information based at least in part on historical data, non-limiting examples of which are provided in U.S. Provisional Application Ser. No. 62/244,828, titled “Utilizing Historical Data to Correct GPS Data in a Network of Moving Things,” filed on Oct. 22, 2015, which is hereby incorporated herein by reference in its entirety.

Additionally, in accordance with various aspects of this disclosure, the networks and/or components thereof presented herein are provided with systems and methods for enhancing the accuracy of position or location of positioning or location information based at least in part on the utilization of anchors, non-limiting examples of which are provided in U.S. Provisional Application Ser. No. 62/244,930, titled “Using Anchors to Correct GPS Data in a Network of Moving Things,” filed on Oct. 22, 2015, which is hereby incorporated herein by reference in its entirety.

Further, in accordance with various aspects of this disclosure, the networks and/or components thereof presented herein are provided with systems and methods for providing communication between applications, non-limiting examples of which are provided in U.S. Provisional Application Ser. No. 62/246,368, titled “Systems and Methods for Inter-Application Communication in a Network of Moving Things,” filed on Oct. 26, 2015, which is hereby incorporated herein by reference in its entirety.

Still further, in accordance with various aspects of this disclosure, the networks and/or components thereof presented herein are provided with systems and methods for probing, analyzing and/or validating communication, non-limiting examples of which are provided in U.S. Provisional Application Ser. No. 62/246,372, titled “Systems and Methods for Probing and Validating Communication in a Network of Moving Things,” filed on Oct. 26, 2015, which is hereby incorporated herein by reference in its entirety.

Yet further, in accordance with various aspects of this disclosure, the networks and/or components thereof presented herein are provided with systems and methods for adapting communication rate, non-limiting examples of which are provided in U.S. Provisional Application Ser. No. 62/250,544, titled “Adaptive Rate Control for Vehicular Networks,” filed on Nov. 4, 2015, which is hereby incorporated herein by reference in its entirety.

Also, in accordance with various aspects of this disclosure, the networks and/or components thereof presented herein are provided with systems and methods for reconfiguring and adapting hardware, non-limiting examples of which are provided in U.S. Provisional Application Ser. No. 62/273,878, titled “Systems and Methods for Reconfiguring and Adapting Hardware in a Network of Moving Things,” filed on Dec. 31, 2015, which is hereby incorporated herein by reference in its entirety.

Additionally, in accordance with various aspects of this disclosure, the networks and/or components thereof presented herein are provided with systems and methods for optimizing the gathering of data, non-limiting examples of which are provided in U.S. Provisional Application Ser. No. 62/253,249, titled “Systems and Methods for Optimizing Data Gathering in a Network of Moving Things,” filed on Nov. 10, 2015, which is hereby incorporated herein by reference in its entirety.

Further, in accordance with various aspects of this disclosure, the networks and/or components thereof presented herein are provided with systems and methods for performing delay tolerant networking, non-limiting examples of which are provided in U.S. Provisional Application Ser. No. 62/257,421, titled “Systems and Methods for Delay Tolerant Networking in a Network of Moving Things,” filed on Nov. 19, 2015, which is hereby incorporated herein by reference in its entirety.

Still further, in accordance with various aspects of this disclosure, the networks and/or components thereof presented herein are provided with systems and methods for improving the coverage and throughput of mobile access points, non-limiting examples of which are provided in U.S. Provisional Application Ser. No. 62/265,267, titled “Systems and Methods for Improving Coverage and Throughput of Mobile Access Points in a Network of Moving Things,” filed on Dec. 9, 2015, which is hereby incorporated herein by reference in its entirety.

Yet further, in accordance with various aspects of this disclosure, the networks and/or components thereof presented herein are provided with systems and methods for coordinating channel utilization, non-limiting examples of which are provided in U.S. Provisional Application Ser. No. 62/270,858, titled “Channel Coordination in a Network of Moving Things,” filed on Dec. 22, 2015, which is hereby incorporated herein by reference in its entirety.

Also, in accordance with various aspects of this disclosure, the networks and/or components thereof presented herein are provided with systems and methods for implementing a network coded mesh network in the network of moving things, non-limiting examples of which are provided in U.S. Provisional Application Ser. No. 62/257,854, titled “Systems and Methods for Network Coded Mesh Networking in a Network of Moving Things,” filed on Nov. 20, 2015, which is hereby incorporated herein by reference in its entirety.

Additionally, in accordance with various aspects of this disclosure, the networks and/or components thereof presented herein are provided with systems and methods for improving the coverage of fixed access points, non-limiting examples of which are provided in U.S. Provisional Application Ser. No. 62/260,749, titled “Systems and Methods for Improving Fixed Access Point Coverage in a Network of Moving Things,” filed on Nov. 30, 2015, which is hereby incorporated herein by reference in its entirety.

Further, in accordance with various aspects of this disclosure, the networks and/or components thereof presented herein are provided with systems and methods for managing mobility controllers and their network interactions, non-limiting examples of which are provided in U.S. Provisional Application Ser. No. 62/273,715, titled “Systems and Methods for Managing Mobility Controllers and Their Network Interactions in a Network of Moving Things,” filed on Dec. 31, 2015, which is hereby incorporated herein by reference in its entirety.

Still further, in accordance with various aspects of this disclosure, the networks and/or components thereof presented herein are provided with systems and methods for managing and/or triggering handovers of mobile access points, non-limiting examples of which are provided in U.S. Provisional Application Ser. No. 62/281,432, titled “Systems and Methods for Managing and Triggering Handovers of Mobile Access Points in a Network of Moving Things,” filed on Jan. 21, 2016, which is hereby incorporated herein by reference in its entirety.

Yet further, in accordance with various aspects of this disclosure, the networks and/or components thereof presented herein are provided with systems and methods for performing captive portal-related control and management, non-limiting examples of which are provided in U.S. Provisional Application Ser. No. 62/268,188, titled “Captive Portal-related Control and Management in a Network of Moving Things,” filed on Dec. 16, 2015, which is hereby incorporated herein by reference in its entirety.

Also, in accordance with various aspects of this disclosure, the networks and/or components thereof presented herein are provided with systems and methods for extrapolating high-value data, non-limiting examples of which are provided in U.S. Provisional Application Ser. No. 62/270,678, titled “Systems and Methods to Extrapolate High-Value Data from a Network of Moving Things,” filed on Dec. 22, 2015, which is hereby incorporated herein by reference in its entirety.

Additionally, in accordance with various aspects of this disclosure, the networks and/or components thereof presented herein are provided with systems and methods for providing remote software updating and distribution, non-limiting examples of which are provided in U.S. Provisional Application Ser. No. 62/272,750, titled “Systems and Methods for Remote Software Update and Distribution in a Network of Moving Things,” filed on Dec. 30, 2015, which is hereby incorporated herein by reference in its entirety.

Further, in accordance with various aspects of this disclosure, the networks and/or components thereof presented herein are provided with systems and methods for providing remote configuration updating and distribution, non-limiting examples of which are provided in U.S. Provisional Application Ser. No. 62/278,662, titled “Systems and Methods for Remote Configuration Update and Distribution in a Network of Moving Things,” filed on Jan. 14, 2016, which is hereby incorporated herein by reference in its entirety.

Still further, in accordance with various aspects of this disclosure, the networks and/or components thereof presented herein are provided with systems and methods for adapting the network, for example automatically, based on user feedback, non-limiting examples of which are provided in U.S. Provisional Application Ser. No. 62/286,243, titled “Systems and Methods for Adapting a Network of Moving Things Based on User Feedback,” filed on Jan. 22, 2016, which is hereby incorporated herein by reference in its entirety.

Yet further, in accordance with various aspects of this disclosure, the networks and/or components thereof presented herein are provided with systems and methods for enhancing and/or guaranteeing data integrity when building or performing data analytics, non- limiting examples of which are provided in U.S. Provisional Application Ser. No. 62/278,764, titled “Systems and Methods to Guarantee Data Integrity When Building Data Analytics in a Network of Moving Things,” Jan. 14, 2016, which is hereby incorporated herein by reference in its entirety.

Also, in accordance with various aspects of this disclosure, the networks and/or components thereof presented herein are provided with systems and methods for performing self-initialization and/or automated bootstrapping of mobile access points, non-limiting examples of which are provided in U.S. Provisional Application Ser. No. 62/286,515, titled “Systems and Methods for Self-Initialization and Automated Bootstrapping of Mobile Access Points in a Network of Moving Things,” filed on Jan. 25, 2016, which is hereby incorporated herein by reference in its entirety.

Additionally, in accordance with various aspects of this disclosure, the networks and/or components thereof presented herein are provided with systems and methods for managing power supply and/or utilization, non-limiting examples of which are provided in U.S. Provisional Application Ser. No. 62/295,602, titled “Systems and Methods for Power Management in a Network of Moving Things,” filed on Feb. 16, 2016, which is hereby incorporated herein by reference in its entirety.

Further, in accordance with various aspects of this disclosure, the networks and/or components thereof presented herein are provided with systems and methods for automating and easing the installation and setup of the infrastructure, non-limiting examples of which are provided in U.S. Provisional Application Ser. No. 62/299,269, titled “Systems and Methods for Automating and Easing the Installation and Setup of the Infrastructure Supporting a Network of Moving Things,” filed on Feb. 24, 2016, which is hereby incorporated herein by reference in its entirety.

In summary, various aspects of this disclosure provide communication network architectures, systems and methods for supporting a network of mobile nodes, for example comprising a combination of mobile and stationary nodes. As a non-limiting example, various aspects of this disclosure provide communication network architectures, systems, and methods for supporting a dynamically configurable communication network comprising a complex array of both static and moving communication nodes (e.g., the Internet of moving things). While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

What are claimed:

1. A method for controlling by a mobile access point (MAP) display of information on a mobile device, comprising:
establishing communication by the MAP with the mobile device;
providing, by the MAP to the mobile device, a party's advertisement to be displayed on the mobile device, additional information for the party's advertisement, and a link to an advertisement page corresponding to the party's advertisement; and
collecting, by the MAP from the mobile device, user interaction information for transmission to a cloud server for monetization,
wherein the user interaction information comprises one or more of:
displaying the party's advertisement,
a user selecting the party's advertisement, and
the user visiting the advertisement page.

2. The method of claim 1, wherein the advertisement is one of normal advertisement or premium advertisement, wherein the normal advertisement is a temporary advertisement and the premium advertisement is a persistent advertisement.

3. The method of claim 2, comprising using rules by the MAP to determine whether to display the normal advertisement or the premium advertisement.

4. The method of claim 3, comprising the MAP receiving the rules from a server.

5. The method of claim 3, comprising the MAP updating the rules with updates from a server.

6. The method of claim 2, wherein the premium advertisement is displayed based on context information for the mobile device.

7. The method of claim 6, wherein the context information comprises one or more of:
physical/geographic location of the MAP; a time of day; a day of week; an occurrence of a public event; mobility patterns of other mobile devices in a neighborhood of the mobile device; and usage by a user of the mobile device of a service provided by a service provider.

8. The method of claim 1, wherein the monetization comprises processing the advertisement information to bill the party for the advertisement.

9. The method of claim 1, wherein transmitting the user interaction information to the cloud server is via a delay tolerant network.

10. The method of claim 1, wherein:
the additional information for the party's advertisement is provided upon receiving a first user interaction from the mobile device, and
a link to the advertisement page corresponding to the advertisement is provided upon receiving a second user interaction from the mobile device.

11. A non-transitory machine-readable storage having stored thereon, a computer program having at least one code section, the at least one code section being executable by one or more processors, for causing the one or more processors to perform operations, comprising:
establishing communication by the MAP with the mobile device;
providing, by the MAP to the mobile device, a party's advertisement to be displayed on the mobile device, additional information for the party's advertisement, and a link to an advertisement page corresponding to the party's advertisement; and
collecting, by the MAP from the mobile device, user interaction information for transmission to a cloud server for monetization,
wherein the user interaction information comprises one or more of:
displaying the party's advertisement,
a user selecting the party's advertisement, and
the user visiting the advertisement page.

12. The non-transitory machine-readable storage of claim 11, wherein the advertisement is one of normal advertisement or premium advertisement, wherein the normal advertisement is a temporary advertisement and the premium advertisement is a persistent advertisement.

13. The non-transitory machine-readable storage of claim 12, wherein the at least one code section is executable to cause the one or more processors to perform operations comprising using rules by the MAP to determine whether to display the normal advertisement or the premium advertisement.

14. The non-transitory machine-readable storage of claim 13, wherein the at least one code section is executable to cause the one or more processors to perform operations comprising the MAP receiving the rules from a server.

15. The non-transitory machine-readable storage of claim 13, wherein the at least one code section is executable to cause the one or more processors to perform operations comprising the MAP updating the rules with updates from a server.

16. The non-transitory machine-readable storage of claim 12, wherein the at least one code section is executable to cause the one or more processors to perform operations comprising displaying the premium advertisement based on context information for the mobile device.

17. The non-transitory machine-readable storage of claim 16, wherein the context information comprises one or more of: physical/geographic location of the MAP; a time of day; a day of week; an occurrence of a public event; mobility patterns of other mobile devices in a neighborhood of the mobile device; and usage by a user of the mobile device of a service provided by a service provider.

18. The non-transitory machine-readable storage of claim 11, wherein the monetization comprises processing the advertisement information to bill the party for the advertisement.

19. The non-transitory machine-readable storage of claim 11, wherein the at least one code section is executable to cause the one or more processors to perform operations comprising transmitting the user interaction information to the cloud server via a delay tolerant network.

20. The non-transitory machine-readable storage of claim 11, wherein the at least one code section is executable to cause the one or more processors to perform operations comprising:
providing the additional information for the party's advertisement upon receiving a first user interaction from the mobile device, and
providing the link to the advertisement page corresponding to the advertisement upon receiving a second user interaction from the mobile device.
